(19) United States
(12) Patent Application Publication
(10) Pub. No.: US 2017/0195102 A1
(43) Pub. Date: Jul. 6, 2017

(54) METHOD AND APPARATUS OF UE AND ENB FOR MTC WITH NARROWBAND DEPLOYMENT

(71) Applicant: Intel IP Corporation, Santa Clara, CA (US)

(72) Inventors: Gang Xiong, Beaverton, OR (US); Seunghee Han, San Jose, CA (US); Debdeep Chatterjee, Mountain View, CA (US); Jong-Kae Fwu, Sunnyvale, CA (US)

(21) Appl. No.: 15/128,370

(22) PCT Filed: Jun. 25, 2015
(86) PCT No.: PCT/US2015/037745

§ 371 Date: Sep. 22, 2016

Related U.S. Application Data
(60) Provisional application No. 62/018,360, filed on Jun. 27, 2014.
(60) Provisional application No. 62/020,313, filed on Jul. 2, 2014.

(51) Int. Cl. H04L 5/00; H04W 72/04; H04L 1/18

(52) U.S. Cl. CPC H04L 5/0055; H04L 1/1825; H04L 1/1812; H04L 1/1822; H04W 72/0413; H04W 72/042; H04W 72/0426; H04W 72/0433

(57) ABSTRACT

Methods, systems, devices, and apparatus including evolved node B (eNB) or user equipment (UE) for machine-type communications (MTC) with narrowband deployment are described. One embodiment includes control circuitry configured to determine a super-frame structure, where the super-frame structure is set, at least in part, on a bandwidth of the narrowband deployment, with a plurality of downlink physical channels areas multiplexed as part of a first downlink super-frame of the super-frame structure. Such an embodiment may include communication circuitry configured to transmit the first downlink super-frame comprising the plurality of multiplexed downlink physical channels, receive a plurality of uplink physical channels, and receive, in response to transmission of the first downlink super-frame, a hybrid automatic repeat request (HARQ) acknowledgement (ACK) or negative acknowledgement (NACK).

### PRIORITY CLAIM

This application claims the benefit of priority to U.S. Provisional Patent Application Ser. No. 62/018,360 filed on Jun. 27, 2014 and to U.S. Provisional Patent Application Ser. No. 62/020,313 filed on Jul. 2, 2014, both of which are incorporated herein by reference in their entirety.

### TECHNICAL FIELD

Embodiments pertain to systems, methods, and component devices for wireless communications, and particularly to machine type communication (MTC).

### BACKGROUND

Machine-Type Communication (MTC) is an emerging technology related to the concept of “Internet of Things (IoT)”. The existing mobile broadband networks were designed to optimize performance mainly for human type of communications and thus are not designed or optimized to meet MTC related requirements.

### BRIEF DESCRIPTION OF THE DRAWINGS

FIG. 1 illustrates a block diagram of a system including an evolved node B (eNB) and a user equipment (UE) that may operate with MTC according to certain embodiments.

FIG. 2 illustrates aspects of system design form MTC with narrowband deployment according to certain embodiments.

FIG. 3 illustrates aspects of control channel design according to certain embodiments.

FIG. 4 illustrates aspects of control channel design according to certain embodiments.

FIG. 5A illustrates aspects of a hybrid automatic repeat request (HARQ) procedure with two HARQ processes for a download according to some example embodiments.

FIG. 5B illustrates aspects of a HARQ procedure with two HARQ processes for an upload according to some example embodiments.

FIG. 6A illustrates aspects of a hybrid automatic repeat request (HARQ) procedure with four HARQ processes for a download according to some example embodiments.

FIG. 6B illustrates aspects of a hybrid automatic repeat request (HARQ) procedure with four HARQ processes for an upload according to some example embodiments.

FIG. 7 illustrates a method that may be performed by an eNB in accordance with certain example embodiments.

FIG. 8 illustrates a method that may be performed by a UE in accordance with certain example embodiments.

FIG. 9 illustrates aspects of physical broadcast channel (PBCH) structure according to some example embodiments.

FIG. 10 illustrates aspects of PBCH structure and transmission time according to some example embodiments.

FIG. 11 illustrates aspects of PBCH structure and transmission time according to some example embodiments.

FIG. 12 illustrates rate matching mechanisms according to some example embodiments.

FIG. 13A illustrates aspects of PBCH resource mapping according to some example embodiments.

FIG. 13B illustrates aspects of PBCH resource mapping according to some example embodiments.

FIG. 13C illustrates aspects of PBCH resource mapping according to some example embodiments.

FIG. 13D illustrates aspects of PBCH resource mapping according to some example embodiments.

FIG. 14 illustrates partial subframe PBCH resource element mapping according to some example embodiments.

FIG. 15 illustrates full subframe PBCH resource element mapping according to some example embodiments.

FIG. 16 illustrates a method according to some example embodiments.

FIG. 17 illustrates a method according to some example embodiments.

FIG. 18 illustrates a method according to some example embodiments.

FIG. 19 illustrates aspects of computing machine according to some example embodiments.

FIG. 20 illustrates aspects of UE in accordance with some example embodiments.

FIG. 21 is a block diagram illustrating an example computer system machine which may be used in association with various embodiments described herein.

### DETAILED DESCRIPTION

Embodiments relate to systems, devices, apparatus, assemblies, methods, and computer readable media to enable MTC using reduced system bandwidth (e.g., 50 KHz, 100 KHz, 200 KHz, 400 KHz, 500 KHz, 600 KHz, etc.). In particular, systems and methods are described for UE associated with an eNB to implement communications with such reduced system bandwidth. The following description and the drawings illustrate specific embodiments to enable those skilled in the art to practice them. Other embodiments can incorporate structural, logical, electrical, process, and other changes. Portions and features of some embodiments can be included in, or substituted for, those of other embodiments. Embodiments set forth in the claims encompass all available equivalents of those claims.

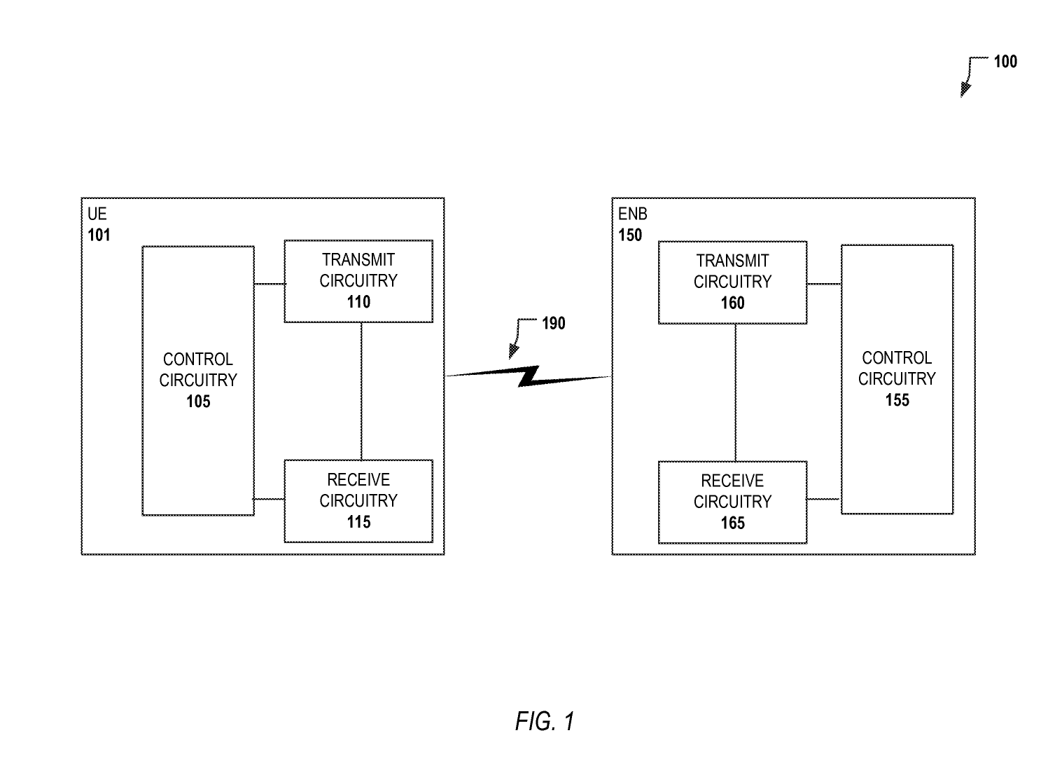

FIG. 1 illustrates a wireless network 100, in accordance with some embodiments. The wireless network 100 includes UE 101 and eNB 150 connected via air interface 190. The UE 101 and any other UE in the system may be, for example, laptop computers, smart phones, tablet computers, printers, machine-type devices such as smart meters or specialized devices for healthcare monitoring, remote security surveillance, an intelligent transportation system, or any other wireless devices with or without a user interface. The eNB 150 provides network connectivity to a broader network (not shown) to UE 101 via air interface 190 in an eNB service area provided by eNB 150. Each eNB service area associated with eNB 150 is supported by antennas integrated with eNB 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of eNB 150, for example, includes three sectors each covering a 120 degree area with an array of antennas directed to each sector to provide 360 degree coverage around eNB 150.

UE 101 includes control circuitry 105 coupled with transmit circuitry 110 and receive circuitry 115. The transmit circuitry 110 and receive circuitry 115 may each be coupled with one or more antennas.

The control circuitry 105 may be adapted to perform operations associated with MTC. The transmit circuitry 110 and receive circuitry 115 may be adapted to transmit and receive data, respectively, within a narrow system bandwidth (e.g., 200 kHz). The control circuitry 105 may perform various operations such as those described elsewhere in this disclosure related to a UE.

Within the narrow system bandwidth, the transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may transmit the plurality of multiplexed uplink physical channels in an uplink super-frame that is comprised of a plurality of uplink subframes.

Within the narrow system bandwidth, the receive circuitry 115 may receive a plurality of multiplexed downlink physical channels. The plurality of downlink physical channels may be multiplexed according to TDM or FDM. The receive circuitry 115 may receive the plurality of multiplexed downlink physical channels in a downlink super-frame that is comprised of a plurality of downlink subframes.

The transmit circuitry 110 and receive circuitry 115 may transmit and receive, respectively, HARQ acknowledgment (ACK) and/or negative acknowledgement (NACK) messages across air interface 190 according to a predetermined HARQ message schedule. The predetermined HARQ message schedule may indicate uplink and/or downlink super-frames in which the HARQ ACK and/or NACK messages are to appear.

FIG. 1 also illustrates eNB 150, in accordance with various embodiments. The eNB 150 circuitry may include control circuitry 155 coupled with transmit circuitry 160 and receive circuitry 165. The transmit circuitry 160 and receive circuitry 165 may each be coupled with one or more antennas that may be used to enable communications via air interface 190.

The control circuitry 155 may be adapted to perform operations associated with MTC. The transmit circuitry 160 and receive circuitry 165 may be adapted to transmit and receive data, respectively, within a narrow system bandwidth (e.g., 200 kHz). The control circuitry 155 may perform various operations such as those described elsewhere in this disclosure related to an eNB.

Within the narrow system bandwidth, the transmit circuitry 110 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

The transmit circuitry 160 and receive circuitry 165 may transmit and receive, respectively, HARQ ACK and/or NACK messages across air interface 190 according to a predetermined HARQ message schedule. The predetermined HARQ message schedule may indicate uplink and/or downlink super-frames in which the HARQ ACK and/or NACK messages are to appear. MTC may then be implemented across air interface 190 using the circuitry of UE 101 and eNB 150. MTC enables a ubiquitous computing environment to enable devices to efficiently communicate with each other. IoT services and applications stimulate the design and development of MTC devices to be seamlessly integrated into current and next generation mobile broadband networks such as long term evolution (LTE) and LTE-Advanced communication systems that operate according to 3^{rd} generation partnership project (3GPP) standards (e.g., 3GPP LTE Evolved Universal Terrestrial Radio Access (E-UTRA) Physical Layer Procedures (Release 12) Sep. 26, 2014).

These existing mobile broadband networks were designed to optimize performance mainly for human type of communications and thus are not designed or optimized to meet the MTC related requirements. MTC systems as described herein function to lower device costs, enhanced coverage, and reduced power consumption. Embodiments described herein particularly reduce cost and power consumption by reducing the system bandwidth, which is corresponding to roughly a single Physical Resource Block (PRB) of existing LTE design. This cellular IoT using reduced system bandwidth could potentially operate in a re-allocated global system for mobile communications (GSM) spectrum, within the guard bands of an LTE carrier, or dedicated spectrum.

When LTE system bandwidth is reduced to a lower bandwidth, certain physical channel designs in existing LTE system cannot be reused because the channel standards are not compatible with the lower bandwidth constraint. Embodiments herein thus describe devices, systems, apparatus, and methods for MTC with narrowband deployment to address the issues identified above due to the narrower bandwidth constraint (e.g., PBCH, SCH, physical random access channel (PRACH), etc.)

Embodiments may thus include a super-frame structure where multiple physical channels can be multiplexed in a TDM manner; control channel design for MTC with narrowband deployment; and HARQ procedure with various number of HARQ processes for MTC with narrowband deployment.

Although the embodiments described below use a 200 kHz bandwidth, the design may be extended to other narrow bandwidth (e.g., 50 KHz, 100 KHz, 400 KHz, 500 KHz, 600 KHz, and etcetera). In addition, the MTC is used as the initial target application for the proposed narrow-band design, the design maybe be extended to other narrow-band deployed applications, (e.g., Device-to-Device, IoT, etc.).

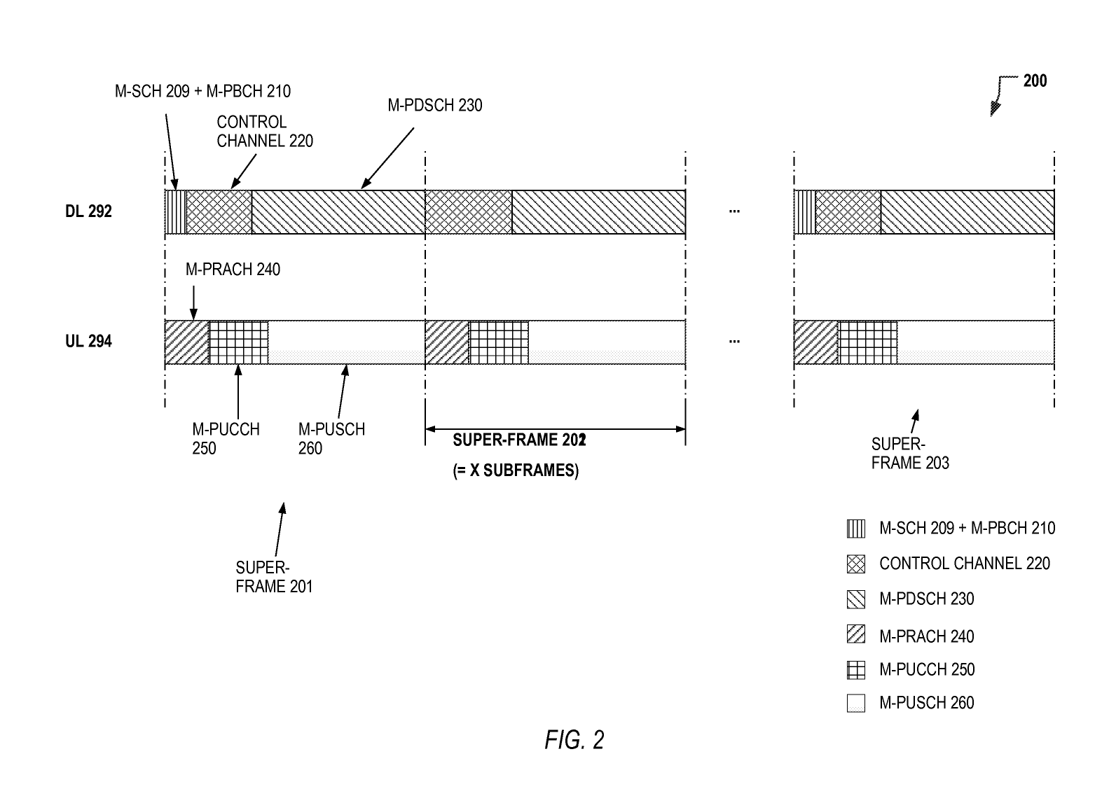

Various physical channels may be used as part of such an MTC. FIG. 2 illustrates one possible implementation of such; channels in channel design 200 are illustrated within super-frames 201, 202, and 203 for both download 292 and upload 294 paths. These physical channels include, but are not limited to, a synchronization channel (M-SCH) 209, a physical broadcast channel (M-PBCH) 210, a control channel 220, a physical downlink shared channel (M-PDSCH) 230, a physical random access channel (M-PRACH) 240, a physical uplink control channel (M-PUCCH) 250, and a physical uplink shared channel (M-PUSCH) 260. These channels and other potential channels are described below.

MTC Synchronization Channel (M-SCH) 209 may include the MTC Primary Synchronization Signal (M-PSS) and/or MTC Secondary Synchronization Signal (M-SSS). It may be used to support time and frequency synchronization and provide the UE with the physical layer identity of the cell and the cyclic prefix length. Note that M-SCH may or may not be utilized to distinguish the Frequency Division Duplex (FDD) and Time Division Duplex (TDD) system although the TDD may not need to be supported in MTC system with narrowband deployment.

MTC Physical Broadcast Channel (M-PBCH) 210 carries MTC Master Information Block (M-MIB), which consists of a limited number of the most frequently transmitted parameters for initial access to the cell.

The MTC control channel includes MTC Physical Downlink Control Channel (M-PDCCH) and/or MTC Physical Control Format Indicator Channel (M-PCFICH) and/or MTC Physical Hybrid ARQ Indicator Channel (M-PHICH). Note that for the downlink data transmission, time domain resource allocation is supported, while for the uplink data transmission, time domain and/or frequency domain resource allocation can be supported.

M-PDSCH 230 is used for all user data, as well as for broadcast system information which is not carried on the PBCH 210, and for paging messages.

M-PUSCH 260 is used for uplink data transmission. It may be used to carry MTC Uplink Control Information (M-UCI) for MTC with narrowband deployment.

M-PRACH 240 is used to transmit the random access preamble. For initial access, it is utilized to achieve uplink synchronization.

M-PUCCH 250 is used to carry M-UCI. In particular, scheduling requests and HARQ acknowledgements for received M-SCH 209 transport blocks can be supported in M-PUCCH 250 transmission. Given the nature of narrowband transmission, it may not be beneficial to support the channel state reports in M-PUCCH 250, which is mainly used to facilitate channel dependent scheduling.

MTC Physical Multicast Channel (M-PMCH) is used to support Multimedia Broadcast and Multicast Services (MBMS).

FIG. 2 illustrates a system design for MTC with narrowband deployment. In the system design, a certain number of subframes are formed as a super-frame (e.g., X subframes are used to form a super-frame as shown in FIG. 2). The starting subframe and duration of the super-frame can be predefined or configured by eNB, where in the latter case, scheduling flexibility can be provided depending on specific system configuration, traffic scenarios, and the like. The duration of the super-frame and the corresponding number of subframes in a super-frame is determined at least in part based on the bandwidth of the narrowband deployment. In various embodiments, the super-frame duration is configured to enable compatibility with standard bandwidth LTE systems for MTC communications operating at narrow bandwidths as described above. In one embodiment, this configuration information can be included in the MIB conveyed in the M-PBCH or it can be carried in another system information block (SIB).

In the super-frame, multiple physical channels are multiplexed in a TDM or FDM) manner More specifically, in the download (DL) 202, either control channel/M-PDSCH or M-SCH/M-PBCH/M-PDSCH/control channel can be multiplexed in one super-frame. For example, as illustrated, super-frame 201 includes M-SCH 209A, M-PBCH 210A, Control channel 220A, and M-PDSCH 230A in the DL 202 of super-frame 201 and M-PRACH 240A, M-PUCCH 250A, and M-PUSCH 260A as segments in the upload (UL) 204 of super-frame 201. Thus, M-PRACH/M-PUCCH/PUSCH can be multiplexed in one super-frame. Note that UL 204 and DL 202 may have certain subframes offset to allow additional processing time. This super-frame structure is also beneficial to address the issue in the coverage limited scenarios. In particular, periodicity of a super-frame can be extended to allow more repetitions for DL 202 and UL 204 transmission, thereby improving the link budget. In certain embodiments, for example, a coverage enhancement target is selected for a system. A coverage enhancement target may be a link budget improvement associated with a periodicity of the super-frame structure. In other words, by increasing the size of a super-frame within the super-frame structure by, for example, increasing the number of subframes in a super-frame and thereby increasing the percentage of a super-frame devoted to data instead of overhead, the link budget is improved. In other embodiments, the size of a super-frame may be based, at least in part, on the bandwidth of the MTC system. In certain embodiments, a super-frame may be set to match the amount of data in an MTC super-frame with the amount of data in a single frame (e.g. 10 subframes) in a standard LTE or LTE-advanced system. In other embodiments, the structure of a super-frame may be based on a combination of coverage enhancement targets and compatibility with other systems based on the bandwidth of the MTC system.

In one embodiment, a MTC region can be defined in order to coexist with a current LTE system. In particular, the starting orthogonal frequency division multiplexing (OFDM) symbols of the MTC region in each subframe can be predefined or configured by a higher layer. For instance, the starting symbol of the MTC region can be configured after the PDCCH region in the legacy LTE system.

In the DL 202, M-PDSCH transmission is scheduled and follows M-PDCCH transmission. Unlike the current LTE specification, cross-subframe scheduling is employed for a MTC system with narrowband deployment. To avoid the excessive blind decoding attempts for M-PDCCH, the starting subframe of M-PDCCH is limited to a subset of the subframes. The configuration regarding the periodicity and offset of M-PDCCH transmission can be predefined or configured by eNB in a device-specific or cell-specific manner In one embodiment, this configuration information can be included in the MIB conveyed in the M-PBCH 210.

M-PBCH 210 is transmitted with periodicity of Y subframes, preceded by an M-SCH 209 transmission. To reduce the overhead and improve the spectrum efficiency, M-PBCH 210 is less frequently transmitted compared to M-PDCCH. In the case when M-PDCCH transmission is collided with M-SCH 209 and M-PBCH 210, the starting subframe of M-PDCCH is delayed by N subframes, where N is the number of subframes allocated for M-SCH 209 and M-PBCH 210 transmission.

Note that certain super-frames can be configured as MBMS Single Frequency Network (MBSFN) super-frames. The M-PBCH 210 may be allocated after the control region in the configured MBSFN super-frame. The configuration information can be configured and transmitted (broadcast or unicast/groupcast) by eNB. As in the existing LTE specification, extended Cyclic Prefix (CP) can be used to facilitate the efficient MBSFN operation by ensuring the signals remain within the CP at the UE receivers.

In the UL, M-PUCCH 250 and M-PUSCH 260 are transmitted after M-PRACH in one super-frame. Although as shown in the FIG. 1, M-PUCCH is followed by M-PUSCH transmission, it can be transmitted in the middle of M-PUSCH or after M-PUSCH. The time location of M-PRACH, M-PUCCH, and M-PUSCH can be predefined or configured by eNB. In one embodiment, this configuration information can be included in the MIB conveyed in the M-PBCH.

In one example, M-PUSCH is transmitted in a subframe #0-#4 and #6-#9, while M-PUCCH is transmitted in the subframe #5. In another example, M-PUSCH is transmitted in the subframe #0-#8, while M-PUCCH is transmitted in the subframe #9. Note that in order to allow adequate processing time for M-PDCCH decoding, the starting subframe of the M-PUSCH transmission may offset certain number of subframes relative to the last subframe of the M-PDCCH transmission.

In one embodiment, M-PCFICH can be considered in the control channel as the current LTE specification. However, unlike the PCFICH in the existing LTE standard, M-PCFICH carries a MTC Control Format Indicator (M-CFI) which is used to indicate the information for M-PDCCH and M-PDSCH transmission (e.g., the time/frequency locations of M-PDCCH transmission). In this case, control channel overhead can be adjusted according to a particular system configuration, traffic scenario, and channel conditions. To simplify the specification effort and implementation, some existing PCFICH designs in current LTE specification can be reused for M-PCFICH design, (e.g., modulation scheme, layer mapping and precoder design). In this case, 16 M-PCFICH symbols are grouped into 4 symbol quadruplets (e.g., resource elements), and each symbol quadruplet can be allocated into one MTC resource element group (M-REG). In other embodiments, other groupings may be used. For example, in another embodiment, the time/frequency locations for M-PDCCH and/or M-PDSCH are predetermined or configured by the higher layers. In this case, M-PCFICH is not needed in the control channel design.

Furthermore, M-PHICH may or may not be included in the control channel. In one embodiment, M-PHICH is not needed in the control channel design. This can be considered if HARQ is not supported for MTC with narrowband deployment or in the case when M-PHICH functionality may be replaced by M-PDCCH.

In another embodiment, M-PHICH is supported to carry the HARQ ACK/NACK, which indicates whether the eNB has correctly received a transmission on the PUSCH. The number of PHICH groups for M-PHICH transmission can be predefined or configured by eNB. In one embodiment, the configuration information can be broadcast in the MTC Master Information Block (M-MIB) conveyed in the MTC Physical Broadcast Channel (M-PBCH) or broadcast in MTC System Information Block (M-SIB). To simplify the specification effort and implementation, some existing PHICH designs in current LTE specification can be reused for M-PHICH design (e.g., modulation scheme, layer mapping, and precoder design). In this case, 12 symbols for one M-PHICH group are grouped into 3 symbol quadruplets, and each symbol quadruplet can be allocated into one MTC resource element group (M-REG).

In the case when M-PCFICH and M-PHICH are supported, several options can be considered in the control region design for MTC with narrowband deployment as follows.

In one embodiment, M-PCFICH is located in the first K₀ subframes of the control region while M-PHICH is allocated in the last K₁ subframes of the control region. In addition, M-PDCCH is allocated in the resource elements which are not assigned for M-PCFICH and M-PHICH in the control region.

In another embodiment, M-PCFICH is located in the first M₀ subframes of the control region while M-PHICH is located in the M₁ subframes of the data region. Similarly, M-PDCCH and M-PDSCH are allocated in the resource elements which are not assigned for M-PCFICH in the control region and M-PHICH in the data region, respectively.

Note that in the example embodiments shown below, continuous resource allocations are considered for MTC control region. Distributed resource allocation for the MTC control region can be easily extended in other embodiments.

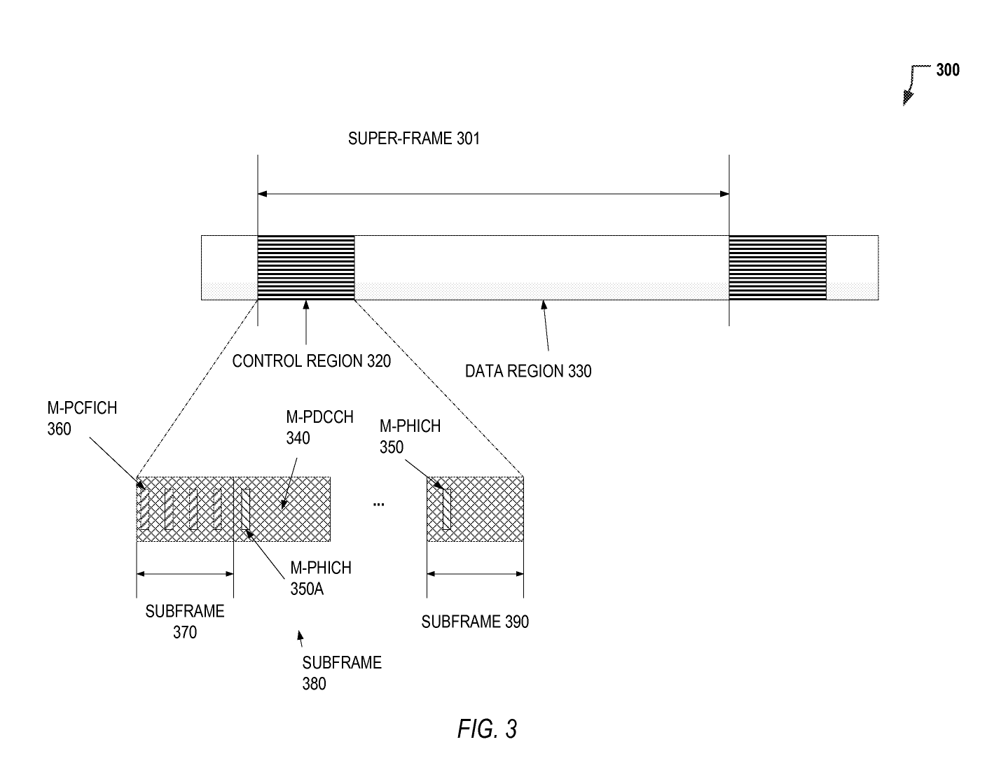

FIG. 3 illustrates one implementation of a control channel 300, according to some embodiments. FIG. 3 shows control region 320 within super-frame 301, with control region 320 followed by data region 330. Control region 320 includes M-PCFICH 360 in subframe 370, M-PHICH 350A in subframe 380, and M-PHICH 350 in subframe 390, with M-PDCCH elements in all subframes including M-PDCCH 340 in subframe 380. In this embodiment, M-PCFICH 360 is located in the first K₀ subframes of the control region, while M-PHICH 350A is allocated in the last K₁ subframes of the control region, where K₀<(N_{control}−1), K₁≦(N_{control}−1) and N_{control} is the number of subframes allocated for control channel. Furthermore, the M-PDCCH 340 transmission is rate-matched or punctured around the allocations for M-PCFICH 360 and M-PHICH 350A transmission. Note that K₀ and K₁ can be predefined or configured by higher layers.

For M-PCFICH 360 resource mapping, four symbol quadruplets can be either separated by approximately one-fourth of the K₀ subframes or allocated in the contiguous M-REGs, with the starting position derived from the physical cell identity. Similarly, for M-PHICH 350A resource mapping, three symbol quadruplets can be either separated by approximately one-third of the K₁ subframes or allocated in the contiguous M-REGs, with the starting position derived from the physical cell identity.

The embodiment of FIG. 3 shows one example of the control region design option 1 for MTC with narrowband deployment. In this example, M-PCFICH 360 is allocated and equally distributed in the first subframe of the control region (i.e., K₀=1). Similarly, M-PHICH 350A is equally distributed from the second subframe to the last subframe of the control region (i.e., K₁=(N_{control}−1)).

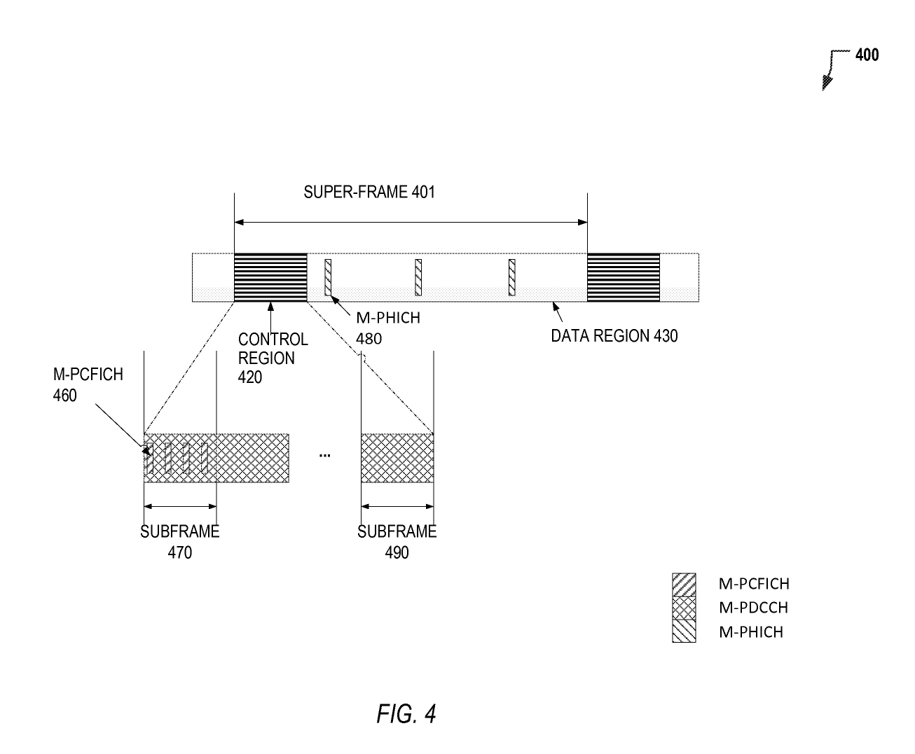

FIG. 4 illustrates another example of the control region design for MTC with narrowband deployment. In this example, M-PCFICH is allocated and equally distributed in the first subframe of the control region (i.e., M₀=1). Similarly, M-PHICH is equally distributed in the data region (i.e., M₁=N_{data}).

Similar to the embodiment of FIG. 3, FIG. 4 shows control region 420 in super-frame 401 with subframes 470, 490, and M-PCFICH 460. Data region 430 follows control region 420. M-PHICH 480, however, is within data region 430. In this option, M-PCFICH 460 is located in the first M₀ subframes of the control region 420, while M-PHICH 480 is located in the M₁ subframes of the data region, where M₀<(N_{control}−1), M₁≦N_{data}, and N_{data} is the number of subframes allocated for the data region. FIG. 4 particularly shows these in the first subframe, while additional embodiments may use related configurations as stated above. Similarly, M-PDCCH and M-PDSCH are allocated in the resource elements that are not assigned for M-PCFICH 460 in the control region and M-PHICH 480 in the data region, respectively. Note that M₀ and M₁ can be predefined or configured by higher layers.

Similar to the initial embodiment of control channel 300, four symbol quadruplets for M-PCFICH 460 transmission can be either separated by approximately one-fourth of the M₀ subframes or allocated in the contiguous M-REGs, with the starting position derived from the physical cell identity. For M-PHICH 480 resource mapping, three symbol quadruplets can be either separated by approximately one-third of the M₁ subframes or allocated in the contiguous M-REGs in the data region, with the starting position derived from the physical cell identity.

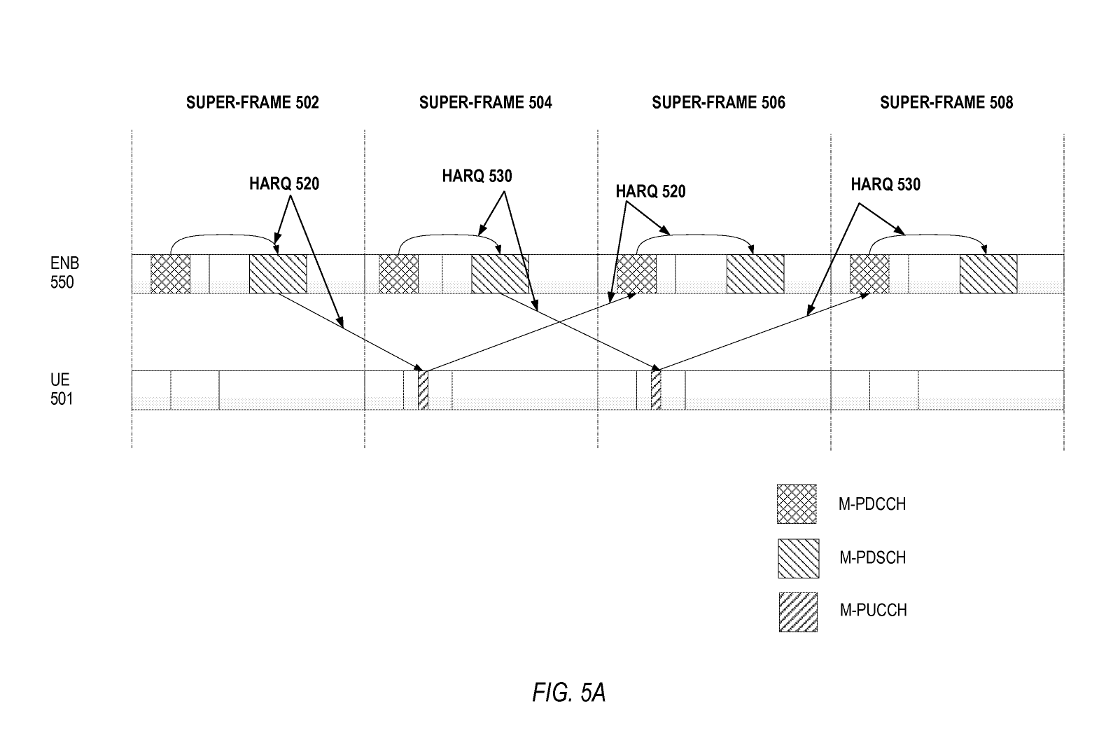

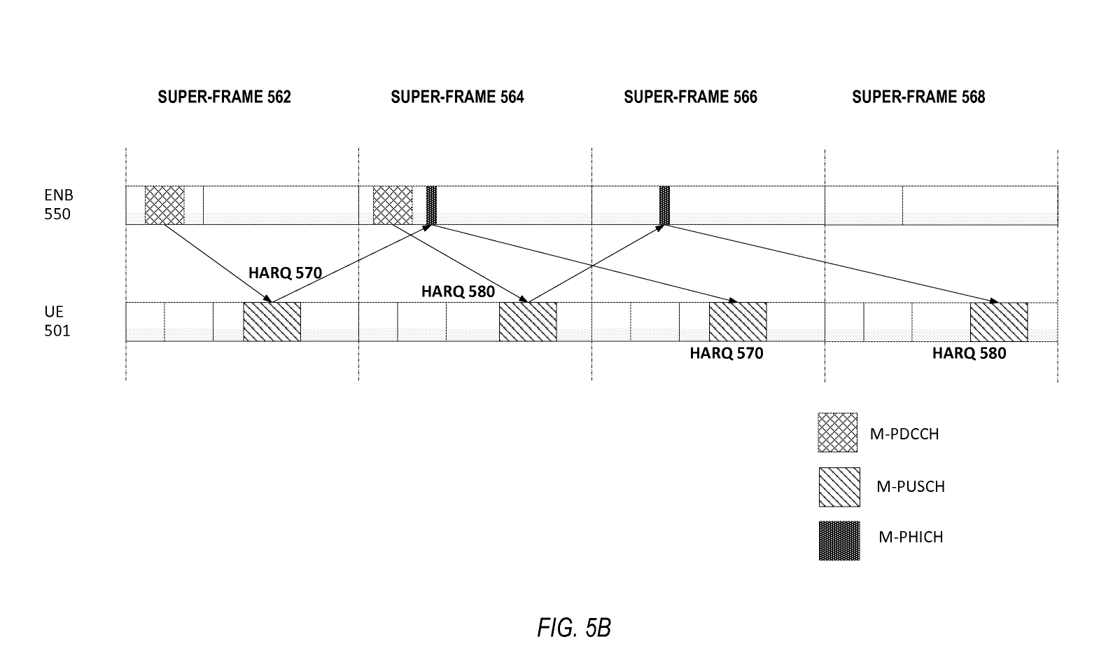

FIGS. 5A and 5B illustrate upload and download HARQ procedure with two HARQ processes implemented by a UE 501 and an eNB 550. FIG. 5A shows a download HARQ procedure with two HARQ processes shown as HARQ 520 and HARQ 530 across super-frames 502-508. FIG. 5B shows an upload HARQ procedure with two HARQ processes shown as HARQ 570 and HARQ 580 across super-frames 562-568.

For the DL HARQ procedure of FIG. 5A, in the super-frame 502, M-PDSCH with HARQ 520 process is scheduled and transmitted. After UE 501 decodes the M-PDSCH, it feeds back ACK/NACK to eNB 550 via M-PUCCH in the super-frame 504. In the case with NACK, eNB 550 would schedule the retransmission in the super-frame 506. Similarly, for HARQ 530 process, initial transmission and retransmission for M-PDSCH are scheduled in the super-frame 504 and 508, respectively, while the ACK/NACK feedback is transmitted via M-PUCCH in the super-frame 506. Unlike the existing LTE specification, the M-PUCCH resource index for HARQ acknowledgement can be associated with the index of either the first control channel elements (CCE) in the M-PDCCH or the starting subframe of the M-PDCCH or the combination of both for the corresponding M-PDSCH transmission. In another embodiment, the M-PUCCH resource index for HARQ acknowledgement can be indicated by the starting subframe of M-PDSCH transmission.

For the UL HARQ procedure of FIG. 5B, in the super-frame 562, M-PUSCH with HARQ 570 process is scheduled and transmitted. Then eNB 550 will send the ACK/NACK via M-PHICH in the super-frame 564. If NACK is received by MTC UE 501, M-PUSCH retransmission would occur in the super-frame 566. A similar design principle is also applied for HARQ 580 process. Unlike the existing LTE specification, the M-PHICH index can be associated with the index of the starting subframe used for the corresponding M-PUSCH transmission.

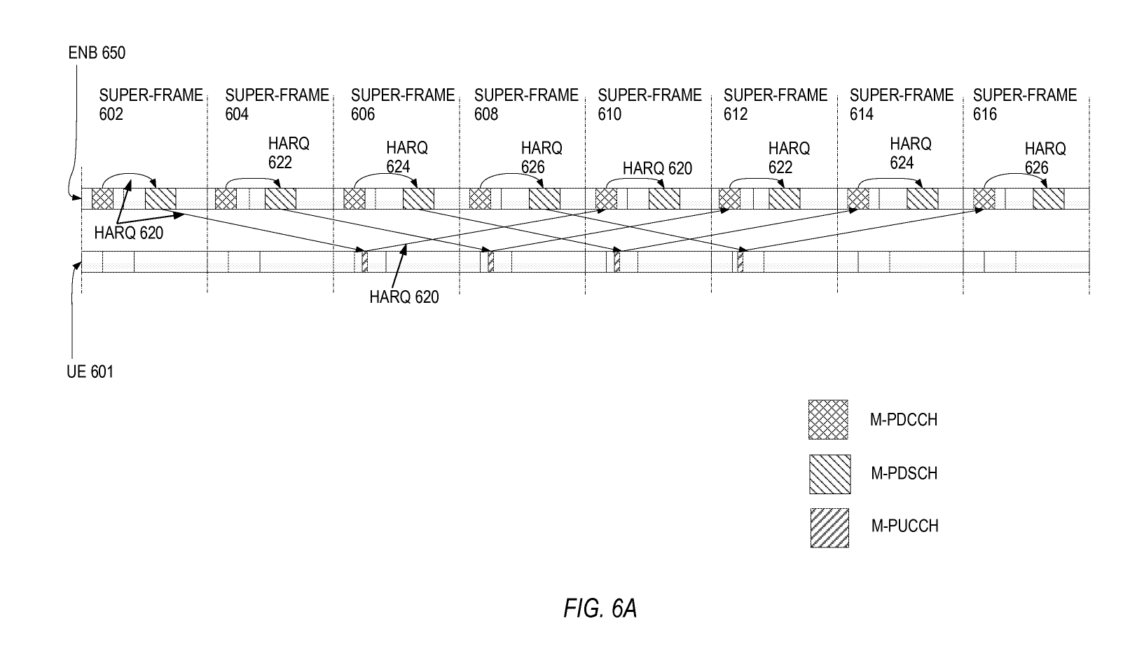

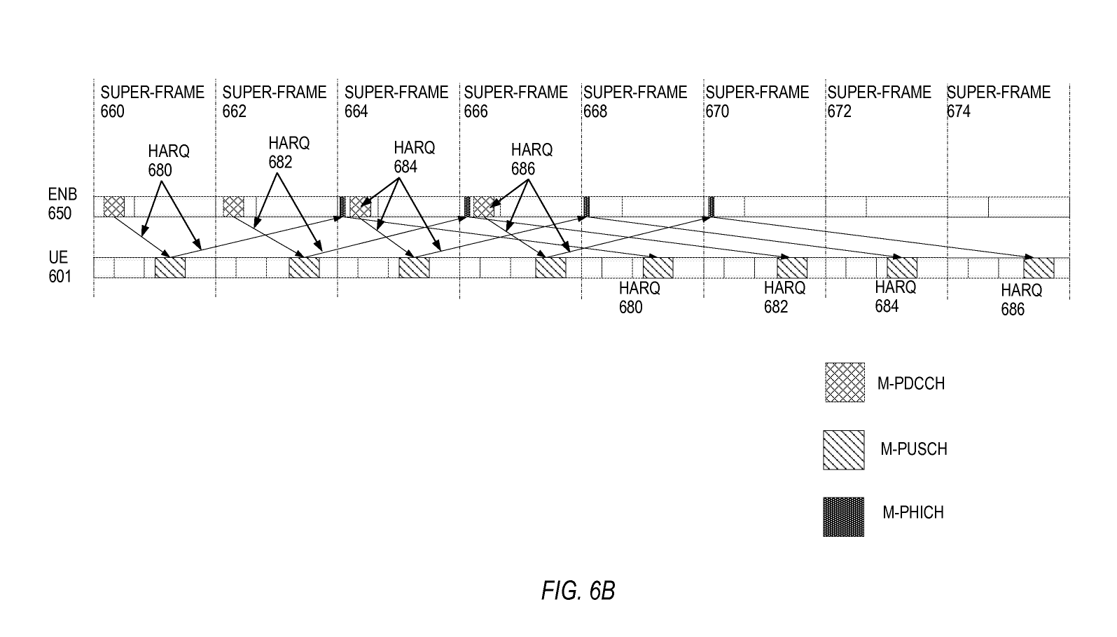

FIGS. 6A and 6B show upload and download HARQ procedures for four HARQ processes. FIG. 6A shows download processes HARQ 620, 622, 624, AND 626 across super-frames 602-616 between UE 601 and eNB 650. FIG. 6B shows upload HARQ processes HARQ 680, 682, 684, and 686 across super-frames 660-674 for eNB 650 and UE 601.

As shown in FIG. 6A, for DL HARQ processes, UE 601 would provide the ACK/NACK feedback via M-PUCCH with a two super-frame delay after it receives the M-PDSCH transmission. Subsequently, the retransmission occurs two super-frames later after eNB 650 receives the NACK.

For UL HARQ processes, the gap between M-PUSCH transmission and ACK/NACK feedback via M-PHICH, as well as between ACK/NACK feedback and M-PUSCH retransmission, is similarly two super-frames.

The same design principle can be generalized and applied for the HARQ procedure with 2×M HARQ processes (M>2). More specifically, the gap between the data transmission (M-PDSCH in the DL and M-PUSCH in the UL) and the ACK/NACK feedback (M-PUCCH in the DL and M-PHICH in the UL), as well as between ACK/NACK feedback and the data retransmission, is M super-frames.

In another embodiment, in the case of HARQ procedure with 2×m HARQ processes (M≧2), an unbalanced processing gap can be introduced to allow an increased time-budget at the UE side. In this option, delay between the retransmission of M-PDSCH and M-PUCCH transmission (for DL HARQ), and the delay between the M-PUSCH retransmission and M-PHICH transmission (for UL HARQ) does not scale with an increase in the number of HARQ processes. For instance, in the case for four HARQ processes with M=2, for DL HARQ, a delay of three super-frames is available for transmission of the M-PUCCH with the DL HARQ information, while a retransmission (in case of a NACK) is scheduled in the next super-frame itself.

In another embodiment, multiple HARQ processes can be scheduled in one super-frame. In this option, multiple M-PDCCHs can be used to schedule multiple M-PDSCHs and/or M-PUSCHs in one super-frame.

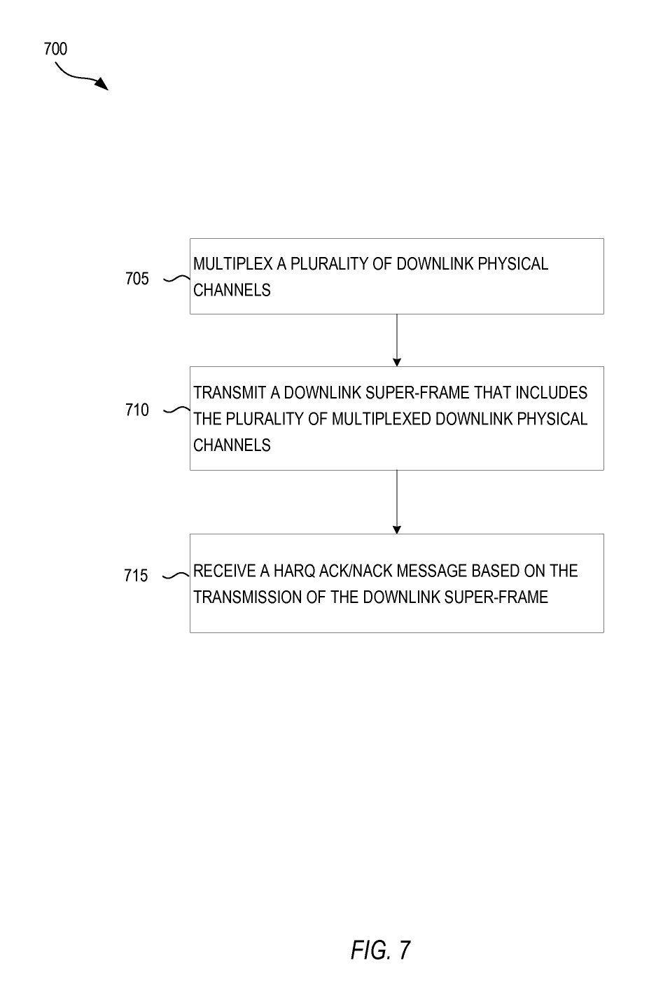

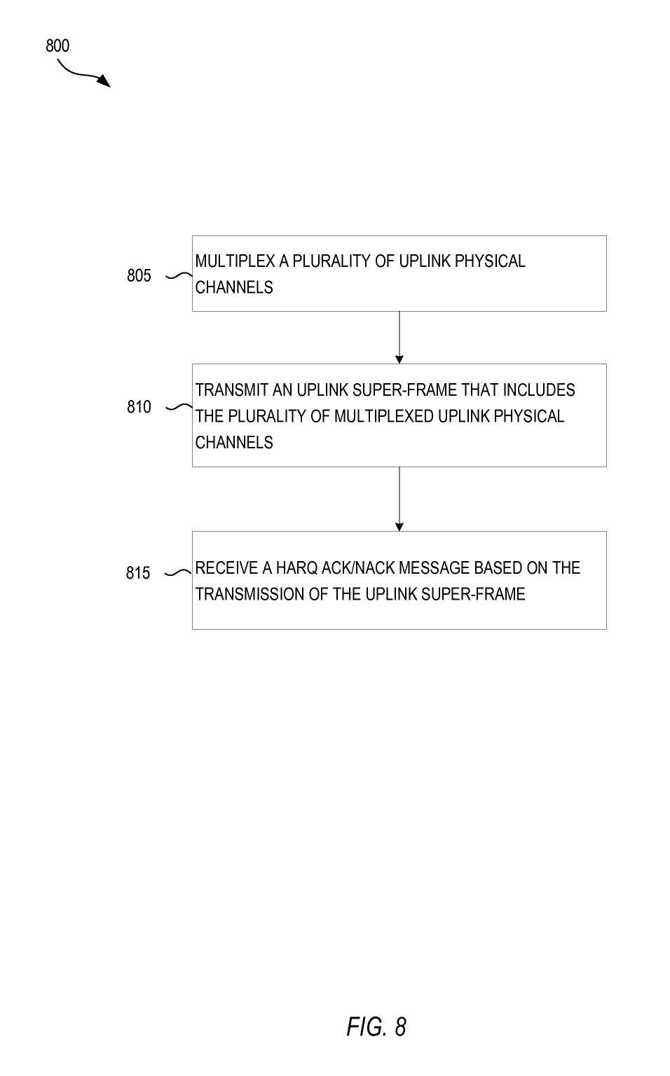

FIGS. 7 and 8 then illustrate methods that may be performed by a UE and an associated eNB such as UE 101 and eNB 150 of FIG. 1. The method 700 may be performed by a UE such as UE 101 or any UE described herein, and may include an operation 705 for multiplexing a plurality of downlink physical channels. The plurality of physical channels may be multiplexed according to TDM or FDM.

The method 700 may further include an operation 710 for transmitting a downlink super-frame that includes the plurality of multiplexed downlink physical channels. In various embodiments, the downlink super-frame may be of a predetermined duration (e.g., comprised of a predetermined number of downlink subframes). The downlink super-frame may comprise a predetermined starting downlink subframe. The operation 710 for transmitting the downlink super-frame may be associated with a predetermined periodicity for transmission.

The method 700 may further include an operation 715 for receiving a HARQ ACK and/or NACK message based on the transmitting of the downlink super-frame. In various embodiments, the HARQ ACK and/or NACK message may be received in an uplink super-frame (e.g., a predetermined plurality of uplink subframes) according to a predetermined schedule for HARQ ACK/NACK message communication (e.g., a HARQ ACK/NACK message may be scheduled to be received in an uplink super-frame immediately following in time the transmission of the downlink super-frame). Optional operations may include retransmitting the plurality of multiplexed downlink physical channels (e.g., in another downlink super-frame according to a predetermined schedule for retransmission) if a HARQ NACK message is received based on the transmitting of the downlink super-frame.

FIG. 8 shows corresponding method 800 that may be performed by circuitry of an eNB such as eNB 150 or any eNB described herein. The method 800 may include an operation 805 for multiplexing a plurality of uplink physical channels. The plurality of uplink physical channels may be multiplexed according to TDM or FDM.

The method 800 may further include an operation 910 for transmitting an uplink super-frame that includes the plurality of multiplexed uplink physical channels. In various embodiments, the uplink super-frame may be of a predetermined duration (e.g., comprised of a predetermined number of uplink subframes). The uplink super-frame may comprise a predetermined starting uplink subframe or a starting uplink subframe that is signaled by an eNB in an information block (e.g., MIB or SIB). The operation 810 for transmitting the uplink super-frame may be associated with a predetermined periodicity for transmission, which may be predetermined or signaled by an eNB in an information block (e.g., MIB or SIB).

The method 800 may further include an operation 815 for receiving a HARQ ACK and/or NACK message based on the transmitting of the uplink super-frame. In various embodiments, the HARQ ACK and/or NACK message may be received in a downlink super-frame (e.g., a predetermined plurality of downlink subframes) according to a predetermined schedule for HARQ ACK/NACK message communication (e.g., a HARQ ACK/NACK message may be scheduled to be received in a downlink super-frame immediately following in time the transmission of the uplink super-frame). Optional operations may include retransmitting the plurality of multiplexed uplink physical channels (e.g., in another uplink super-frame according to a predetermined schedule for retransmission) if a HARQ NACK message is received based on the transmitting of the uplink super-frame.

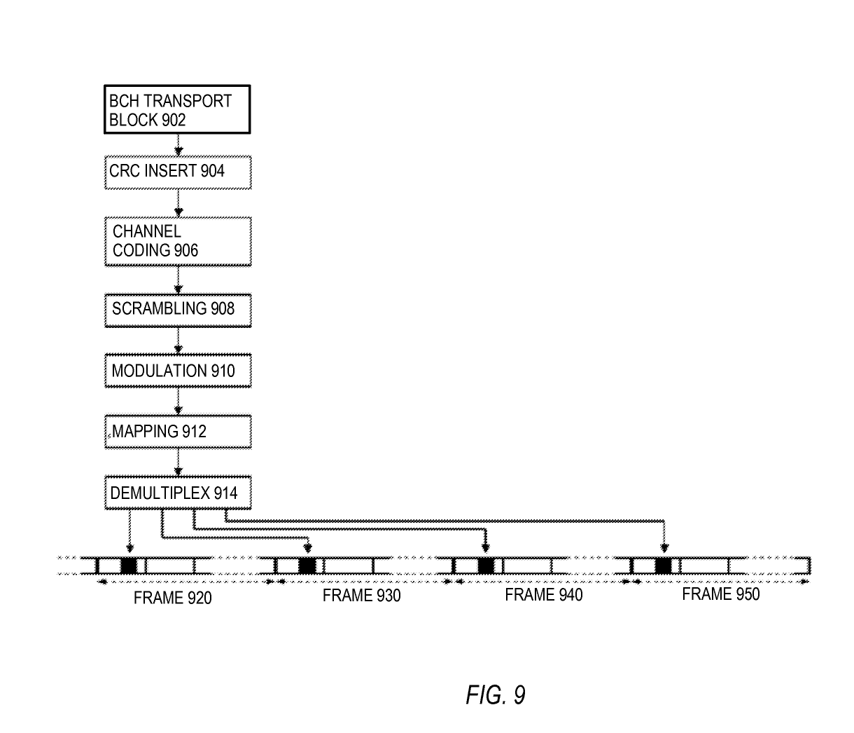

FIG. 9 illustrates PBCH structure in an LTE system. In LTE, the broadcast channel (BCH) transport block 902 carries Master Information Blocks (MIB). MIB includes the information about downlink cell bandwidth, PHICH configuration, System Frame Number (SFN). In particular, one MIB contains 14 information bits and 10 spare bits, which is appended by a 16 bit CRC in CRC insert 904. The Tail Biting Convolutional Code (TBCC; R=⅓ tail-biting convolutional code) is applied to the CRC-attached information bits and then rate-matched with the encoded bits is performed, which produces 1920 encoded bits and 1728 encoded bits for normal and extended CP, respectively. The rate-matched operation could be regarded as the repetition, in this case, of the encoded bits by ⅓ mother coding rate—that is, 120 (=40×3) encoded bits are repeated to fill out the available REs for PBCH. Subsequently, cell-specific scrambling code in scrambling 908 are generated on top of the encoded bits and are applied not only to detect one of four radio frames (2-bit LSB of SFN) but also to provide the interference randomization among the cells. Mapping 912 and demultiplexing 914 result in, the same 480 encoded bits repeated with the different phases at every 10 ms (in each of frame 920, 930, 940, and 950) for 40 ms (10 ms per frame x 4 frames 920,930,940,950) in normal CP while the different 432 encoded bits are repeated with the different phases at every 10 ms for 40 ms in extended CP.

The cell-specific scrambling code is re-initialized at every 40 ms and thus can provide the function to distinguish 2-bit LSB (Least Significant Bit) of SFN, which is the 10 ms (one radio frame) boundary detection among 40 ms (4 radio frames) by means of the different phases of cell-specific scrambling sequences. A UE would require four blind decoding attempts to find out the 2-bit LSB of SFN while 8-bit MSB (Most Significant Bit) of SFN is explicitly signaled by the PBCH contents.

Transmit antenna diversity may be also employed at the eNB to further improve coverage, depending on the capability of the eNB. More specifically, eNBs with two or four transmit antenna ports transmit the PBCH using a Space-Frequency Block Code (SFBC). Note that PBCH is transmitted within the first four OFDM symbols of the second slot of an initial subframe and only over the 72 center subcarriers. Thus, in the case of FDD, PBCH follows immediately after the Primary Synchronization Signal (PSS) and Secondary Synchronization Signal (SSS) in the initial subframe.

A new PBCH (e.g. a M-PBCH) is used when system bandwidth is reduced below the standard LTE or LTE-advanced bandwidth. As mentioned above, the bandwidth for the MTC system may be various different bandwidths as described above, but for the purposes of example, the embodiments detailed below are described with respect to a 200 KHz example embodiment. The main design aspect for the M-PBCH structure are below. In addition, while the MTC is used as the initial target application for the proposed narrow-band design, the design maybe be extended to other narrow-band deployed applications which are not specifically machine-type communications, such as non-machine-type communications in IoT and device to device communications.

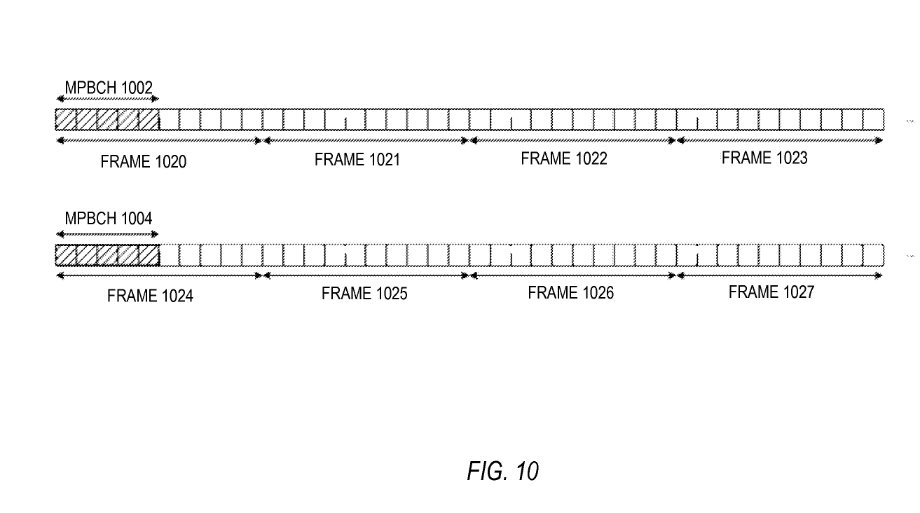

FIG. 10 then illustrates aspects of M-PBCH transmission time in accordance with one example embodiment. In some embodiments, a single M-PBCH block, i.e., B=1, can be transmitted during X×10 ms intervals. This may help to reduce the number of blind decoding attempts, and consequently low power consumption for MTC devices implemented according to certain embodiments described herein. FIG. 10 illustrates a corresponding M-PBCH transmission time. Unlike transmitting PBCH at every radio frame in standard LTE systems, M-PBCH according to some embodiments described herein is transmitted at every X radio frames (e.g. a periodicity of M-PBCH in the embodiment is X frames) where it conveys SFN related information. Each M-PBCH occupies L subframes. In this example of FIG. 10, X=4 and L=5. M-PBCH 1002 in radio frame 1020 may contain SFN related information K₀ and M-PBCH 1004 in radio frame 1024 may contain SFN related information K₁. The SFN related information may represent any SFN among any radio frame within the given periodicity. M-PBCH 1002 may thus contain information for any of radio frames 1020, 1021, 1022, and 1023. M-PBCH 1004 may similarly contain information for any of radio frames 1024, 1025, 1026, and 1027. In this case, the conveyed SFN related information can identify the radio frame based on transmitted M-PBCH location (i.e. radio frame). As a special case, the SFN related information may represent the first radio frame within a periodicity. In this example, K₀ as SFN related information in the first opportunity is K₀=N and K₁ as SFN related information in the next opportunity is K₁=N+4. As another special case, the SFN related information may represent the radio frame transmitting M-PBCH within a periodicity; in this example, K₀ as SFN related information at the first opportunity is K₀=N and K₁ as SFN related information at the next opportunity is K₁=N+4. Once a system determines the M-PBCH location with SFN related information, the other SFN for other radio frames within a periodicity can be also identified accordingly.

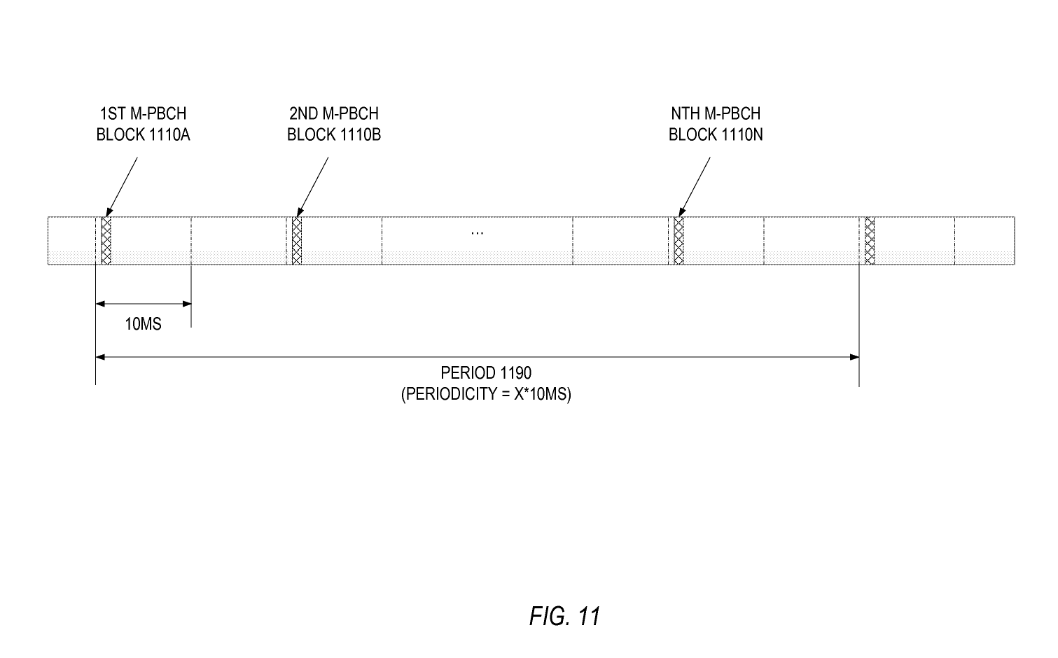

FIG. 11 illustrates another alternate example according to some embodiments. In a system implemented according to FIG. 11, multiple M-PBCH blocks (e.g., N>1) can be transmitted during an X×10 ms interval. FIG. 3 illustrates an M-PBCH transmission time according to such an embodiment. As shown in the figure, M-PBCH can be transmitted with periodicity of X×10 ms and within this X×10 ms, N M-PBCH blocks can be transmitted. FIG. 11 illustrates this with 1^{st} M-PBCH block 1110A, 2^{nd} M-PBCH block 1110B, and Nth M-PBCH block 1110N illustrated within the shown period 1190. In other words, the scrambling code is re-initialized at every X×10 ms and N different scrambling phases are generated within X×10 ms. While 10 ms is used as a base time for each subframe, in other embodiments, other bases may be used such that a period is X*(base time).

In the embodiment of FIG. 11, MTC devices need to perform multiple blind decoding attempts to obtain MTC Master Information Block (M-MIB) information. It is worth mentioning that when multiple scrambling phases are employed for M-PBCH transmission, the number of bits in the SFN information in the M-MIB may be reduced, thereby improving the decoding performance.

In some additional embodiments, the same scrambling phase is used for the N M-PBCH blocks. Accordingly, the number of subframes (L above) occupied by each M-PBCH block can be reduced. This avoids the increase in the number of blind decoding attempts at the UE-side at the expense of longer M-PBCH acquisition time.

In embodiments where M-PBCH follows the same transmission periodicity as the existing PBCH, i.e., X=N=4, the transmission overhead can be substantial, e.g., up to 10% if one subframe is allocated for one M-PBCH transmission within 1 radio frame. To further reduce the overhead and consequently improve the spectrum efficiency, certain embodiments reduce the number of M-PBCH transmission blocks and extend the periodicity to avoid such transmission overhead.

Table 1 below then illustrates M-MIB content for M-PBCH design. M-MIB consists of a limited number of the most frequently transmitted parameters essential for initial access to the cell. In the case when LTE with narrowband deployment coexists with an LTE standard system, information regarding downlink system bandwidth is needed. In addition, in some embodiments, current 3 bit indications can be reused with one additional entry used for narrowband bandwidth. In other embodiments, when an embodiment of MTC (e.g. LTE with narrowband deployment) does not coexist with a standard LTE system, such downlink system bandwidth may not be needed.

The configuration for the number of PHICH groups for M-PHICH transmission may be included in the M-MIB. As the number of OFDM symbols used for PHICH transmission may be fixed, this configuration information may not be needed in some embodiments M-MIB. Furthermore, in some embodiments it may be beneficial to include the configuration for other physical channels (e.g. PDCCH, PRACH, PUCCH, etc.) for use by the system. For example, in some embodiments, the configuration regarding the starting subframe and offset of certain physical channels may be included and used in system operation.

Embodiments described herein may operate with MIB content including information about the SFN. The exact number of bits for SFN depends on the periodicity and number of scrambling phases for M-PBCH transmission. As mentioned above, if single M-PBCH block, i.e., B=1, is transmitted during X×10 ms interval, the number of bits for SFN in M-MIB is 10. In another example embodiment, if M-PBCH transmission periodicity is 80 ms and 8 M-PBCH blocks are transmitted during 80 ms interval, i.e., X=N=8, the number of the bits for SFN in M-MIB can be 10-log₂ (8)=7 bits.

Based on the analysis above, Table 1 summarizes the potential M-MIB content for M-PBCH design according to certain embodiments. Note that certain number of spare bits may be reserved for further release.

TABLE 1
M-MIB content for M-PBCH design

| Parameters | Number of bits |
|---|---|
| Downlink system bandwidth | 0 or 3 |
| Configuration for super-frame | Z bits |
| Configuration for other physical | Y bits |
| channels | |
| SFN information | 10 or less |

Table 2 below then describes aspects of CRC insertion as mentioned above in CRC insert 904 of FIG. 9. In some embodiments, existing 16 bit CRC can be reused. In addition, the same operation on CRC mask with a codeword corresponding to the number of transmit antenna ports can be employed for M-PBCH design.

In other embodiments, 8 bit CRC can be considered to further reduce the coding rate and thus improve the M-PBCH decoding performance. For instance, the 8 bit CRC as defined in current LTE specification can be considered:

g_{CRC8}(D)=[D⁸+D⁷+D⁴+D³+D+1] (1)

Moreover, a new 8-bit CRC mask for M-PBCH transmission may be used in some embodiments. One example of 8-bit CRC mask corresponding to different number of transmit antenna ports is given in Table 2.

TABLE 2
new CRC mask for M-PBCH transmission

| Number of transmit antenna | M-PBCH CRC mask |
|---|---|
| ports at eNodeB | <x_{ant, 0}, x_{ant, 1}, . . . , x_{ant, 7}> |
| 1 | <0, 0, 0, 0, 0, 0, 0, 0> |
| 2 | <1, 1, 1, 1, 1, 1, 1, 1> |
| 4 | <0, 1, 0, 1, 0, 1, 0, 1> |

In other embodiments, a CRC mask with the codeword corresponding to the number of transmit antenna ports is not employed for M-PBCH transmission. Such embodiments reduce the number of blind detection attempts and consequently reduce UE power consumption. This may be realized by carrying the information regarding the number of transmit antenna ports in the MTC Synchronization Channel (M-SCH) transmission. As the UE needs to perform timing and frequency acquisition through M-SCH first, the information for the number of transmit antenna ports may be made available before the UE attempts to decode the M-PBCH.

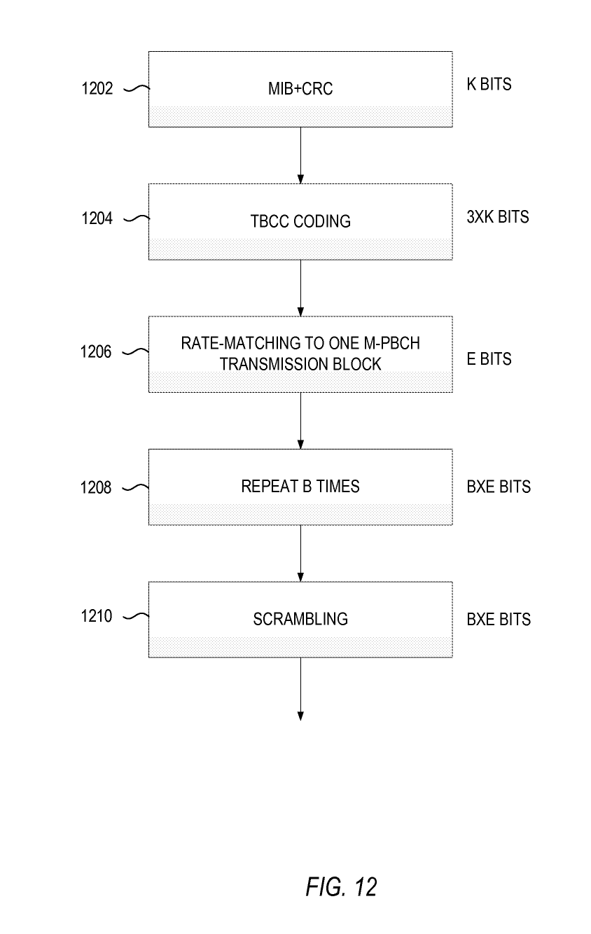

FIG. 12 then illustrates aspects of channel coding and rate matching according to certain embodiments. In certain embodiments, to reduce implementation costs, existing TBCC coding schemes can be reused. In such embodiments, after the channel coding, then rate matching (repetition) is performed to fill out the available REs for M-PBCH transmission. Unlike the existing rate matching scheme for standard LTE PBCH, the number of repetitions in rate-matched MTC may not be an integer number depending on the number of available REs allocated for M-PBCH transmission. For instance, assuming M-MIB size for M-PBCH as 12 bits. With 16 bit CRC and ⅓ TBCC coding, the number of encoded bits becomes 3×(16+12)=84 bits. Without loss of generality, assuming that all REs in the subframe are available for M-PBCH transmission, the number of available REs is 144, which corresponds to 288 bits with QPSK. With 4 different scrambling phases for M-PBCH transmission, the number of repetitions in rate-matched is 288×4/84=13.7, which is not an integer number.

To address this issue, some embodiments operate where the existing rate-matched scheme can be reused. In particular, the rate matching may be performed on B M-PBCH transmission blocks as in current PBCH transmission. After the scrambling, the information bits are equally divided into B segments, (e.g. B=4). Given the non-integer repetitions in the rate that is matched, the starting position of each M-PBCH block before scrambling may be different, which would increase the blind detection complexity.

In other embodiments, rate matching is performed on one M-PBCH transmission block. Then the output of rate matching is repeated by B times for scrambling. FIG. 4 illustrates one potential rate match mechanism in case of non-integer repetitions. In operation 1202, the MIB and CRC operations occur, with an output of K bits. In 1204, TBCC coding occurs with an output of 3×K bits. In operation 1206, rate matching to one M-PBCH transmission block occurs, with a result of E bits. After B reputations in operation 1208, B×E bits result. After the scrambling in operation 1210, the information bits are equally divided into B segments for further processing. In embodiments with this option, the starting position of each M-PBCH blocks before scrambling is aligned, which would reduce the blind detection complexity.

After the channel coding and rate-match, scrambling is performed in order to randomize the interference. In the M-PBCH design, similar scrambling procedure as is used in the existing LTE specification can be applied. In particular, the scrambling sequence can be initialized with C(init)=N(cell id). Subsequently, a modulation scheme may be applied with layer mapping and precoding which is the same as in the standard LTE specification to simply the implementation of the M-PBCH design.

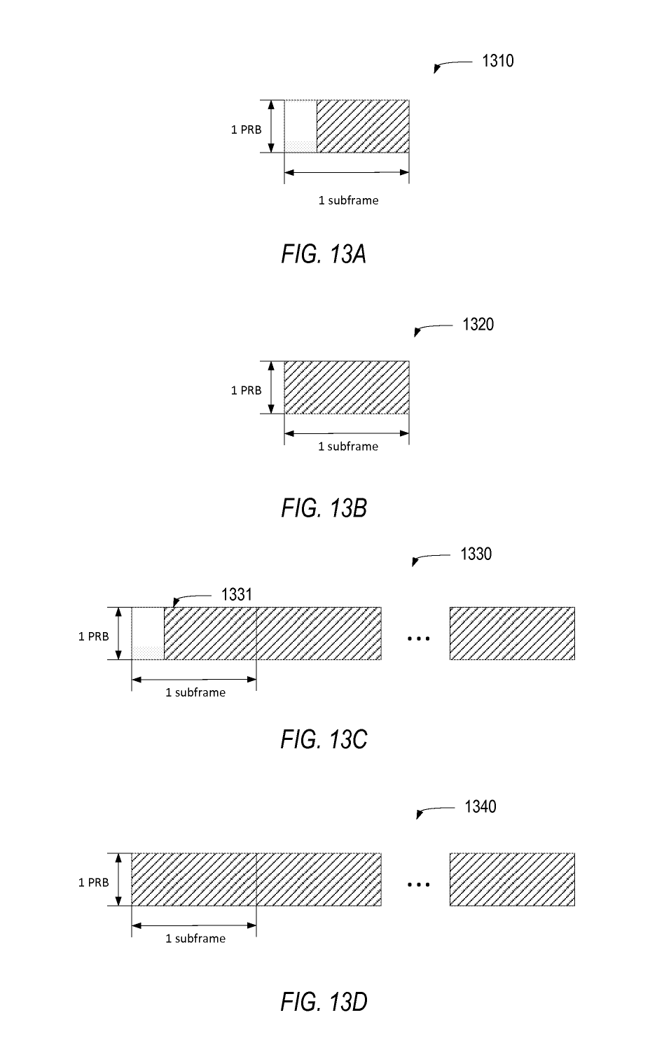

FIGS. 13A-D then illustrate aspects of resource element mapping according to various embodiments. As one PRB is considered as the system bandwidth, certain design change is needed for resource mapping for M-PBCH transmission. Similar to the existing mapping scheme, the mapping to resource elements not reserved for transmission of reference signals may be in increasing order of first the frequency index k, then the symbol index l. In addition, the mapping operation may assume cell-specific reference signals for antenna ports 0-3 being present irrespective of the actual configuration. Depending on the exact M-MIB size, different options can be considered for M-PBCH resource mapping.

FIG. 13A illustrates a first example for M-PBCH resource mapping according to some embodiments. In FIG. 13A, part of one subframe 1310 is allocated for M-PBCH transmission. This option may be suitable for smaller M-MIB size. Further, the remaining symbols in the same subframe 1310 may be allocated for PSS/SSS transmission. Note that the location of subframe 1310 shall be fixed in the specification (e.g. can be 1^{st} subframe) in each radio frame.

FIG. 13B illustrates a second example for M-PBCH resource mapping according to some embodiments. In the embodiment of FIG. 13B, one full subframe 1320 is allocated for M-PBCH transmission. This option may be suitable for smaller M-MIB size. Note that the location of subframe 1320 may be fixed in the specification, just as above.

FIG. 13C illustrates another example for M-PBCH resource mapping according to some embodiments. In the embodiment of FIG. 13C, M-PBCH transmission spans multiple subframes 1330, while in the 1^{st} subframe of multiple subframes 1330 a partial subframe 1331 is used. This option may be more appropriate for larger M-MIB size or coverage limited scenario. In such an embodiment, the number of subframe used for M-PBCH may be predefined in the specification.

FIG. 13D illustrates another example of M-PBCH resource mapping according to some embodiments. In the embodiment of FIG. 13D, M-PBCH transmission spans multiple full subframes 1340. This option may be more appropriate for larger M-MIB size or coverage limited scenario. In such embodiments, the number of subframe used for M-PBCH may be predefined in the specification.

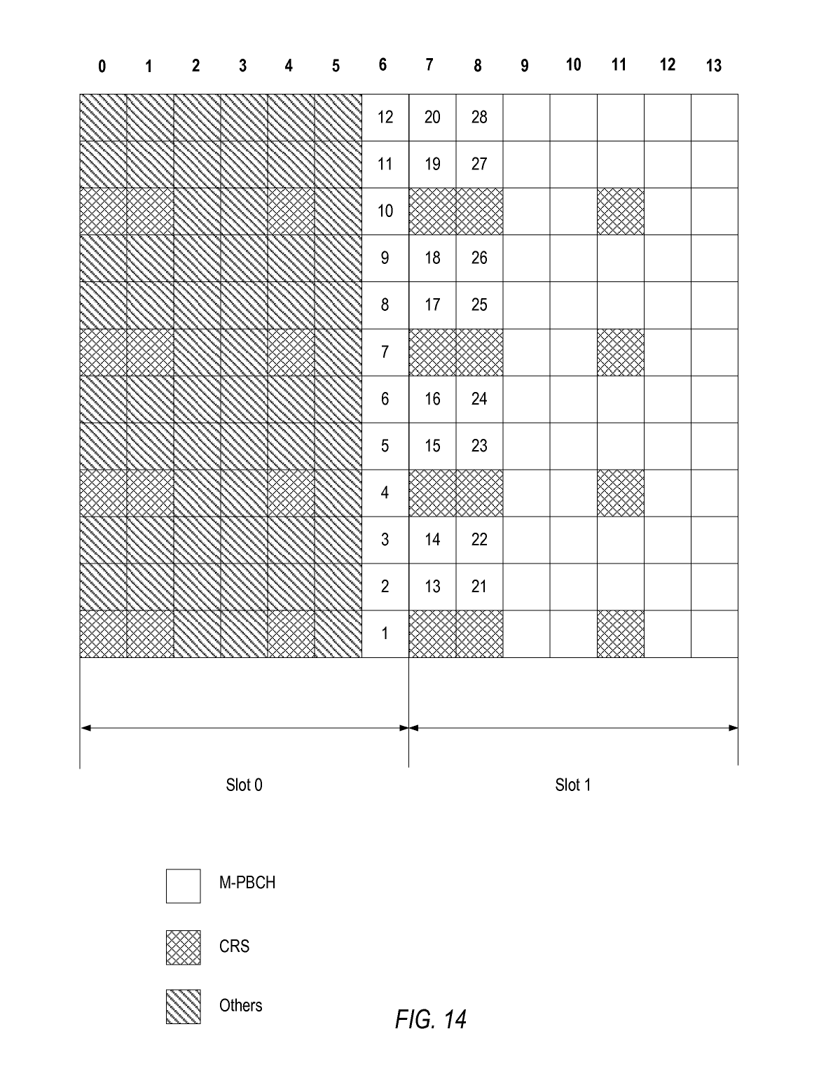

FIG. 14 illustrates a mapping scheme for embodiments using a partial subframe for M-PBCH transmission. In the example of FIG. 14, the M-PBCH transmission starts from the 6^{th} OFDM symbol in the CP case identified for standard LTE operation. As shown in the figure, the mapping to the resource mapping is in the increasing order of first frequency index, and then in the order of the symbol index. In some embodiments, when multiple subframes are used for M-PBCH transmission, the starting index of resource elements in the subsequent subframes follow the last index of resource element in the preceding subframe.

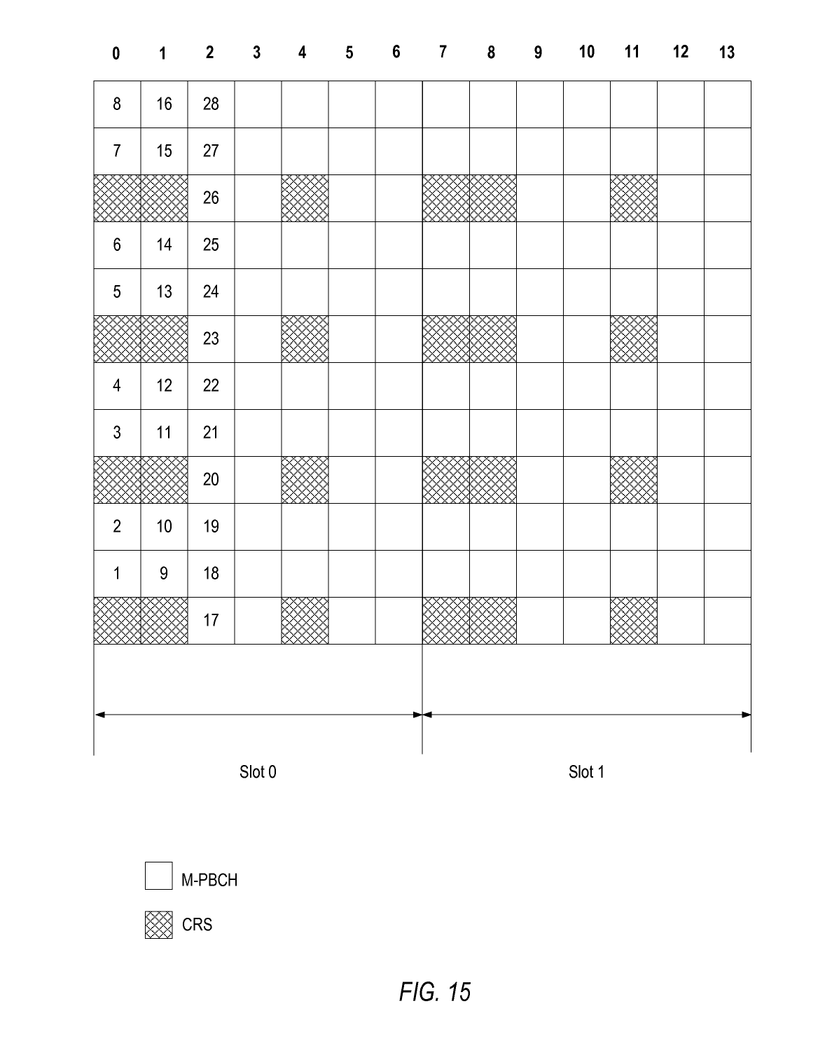

FIG. 15 illustrates a mapping scheme for embodiments using a full subframe for M-PBCH transmission. Similar to the scheme above, the mapping to the resource mapping in FIG. 15 is in the increasing order of first frequency index, and then in the order of symbol index. In certain embodiments where multiple subframes are used for M-PBCH transmission as illustrated in FIG. 13D the starting index of resource elements in the subsequent subframes follow the last index of resource element in the preceding subframe. FIGS. 14 and 15 illustrate embodiments in the normal CP case, but it will be apparent that embodiments may be implemented with the extended CP using the principles illustrated above for the normal CP.

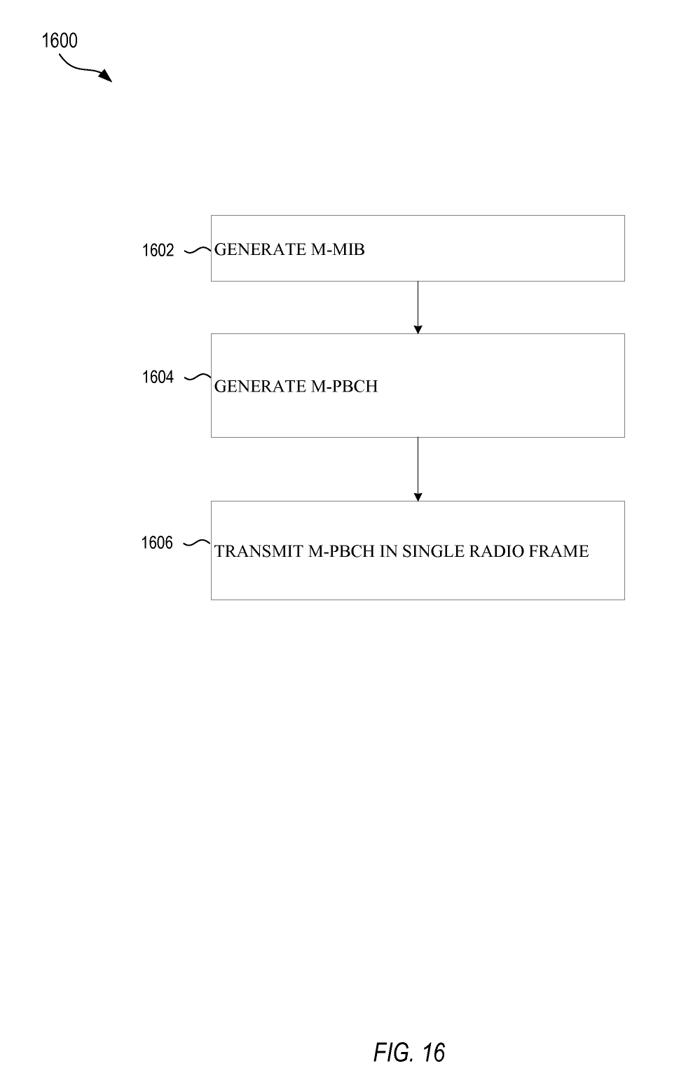

FIG. 16 illustrates a method 1600 that may operate according to certain embodiments described herein. Method 1600 may be performed by circuitry of an eNB such as eNB 150 of FIG. 1 or any other such circuitry or eNB where the control circuitry may be configured to identify a configuration of a MTC master information block (M-MIB). Further, the eNB control circuitry may be configured to generate the M-MIB according to the identified configuration. Further, the eNB control circuitry may be configured to generate a MTC physical broadcast channel (M-PBCH) block that includes the generated M-MIB. Further, the eNB control circuitry may be configured to identify radio resources in a single radio frame on which to transmit the M-PBCH block. In some embodiments, the transmitter may be configured to transmit the M-PBCH block on the identified radio resources in the radio frame. Method 1600 then involves, in operation 1602, generating, by an evolved NodeB (eNB) in a wireless network configured for machine-type communication (MTC), a MTC master information block (M-MIB). The method 1600 may further include, in operation 1604, generating, by the eNB, a MTC physical broadcast channel (M-PBCH) block that includes the generated M-MIB. Operation 1606 then involves transmitting, by the eNB, the M-PBCH block on radio resources of a single radio frame. In other embodiments, the eNB circuitry may be configured to perform methods or processes described with respect to the eNB in other portions of this disclosure.

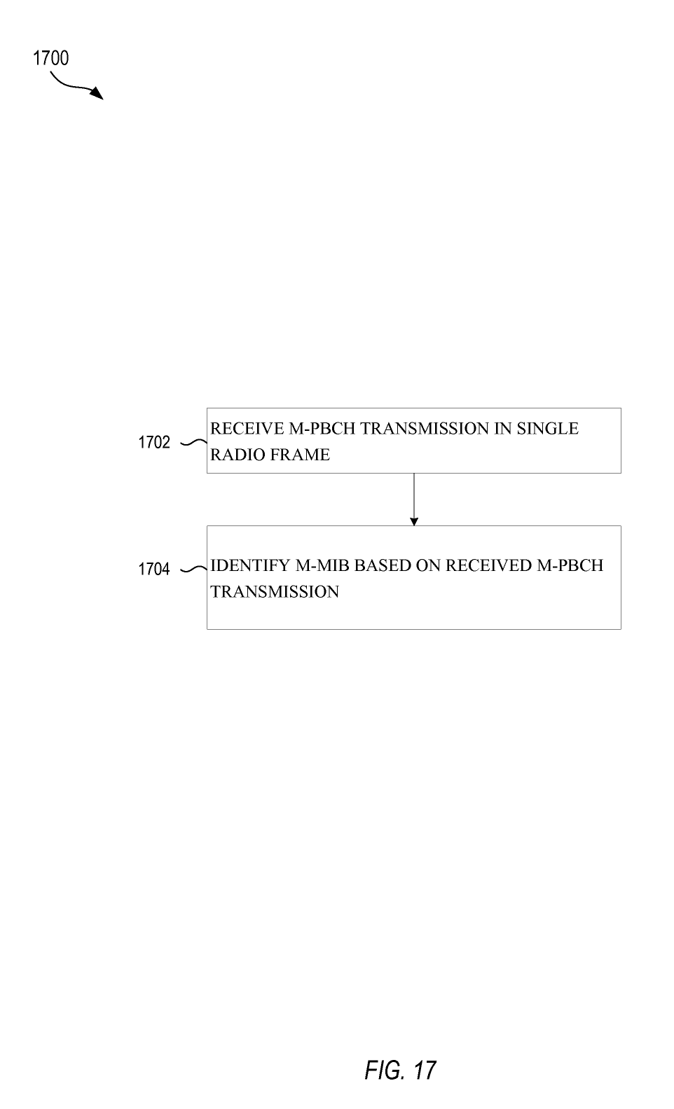

FIG. 17 then illustrates a method 1700 that may operate according to certain embodiments described herein. Method 1700 may be performed by circuitry of a UE such as UE 101 above or any other such UE where receiver circuitry of the UE may be configured to receive a MTC physical broadcast channel (M-PBCH) transmission on one or more subframes of a single radio frame. The control circuitry of such a UE may similarly be configured to identify, based on the received M-PBCH transmission, data in a MTC master information block (M-MIB). Method 1700 includes operation 1702 involving receiving, by a user equipment (UE) operating in a wireless network according to machine-type communication (MTC), a MTC physical broadcast channel (M-PBCH) transmission on one or more subframes of a single radio frame. The method 1700 may further include, as part of operation 1704, identifying, by the UE and based on the received M-PBCH transmission, data in a MTC master information block (M-MIB). In other embodiments, the UE circuitry may be configured to perform methods or processes described with respect to the UE in other portions of this disclosure.

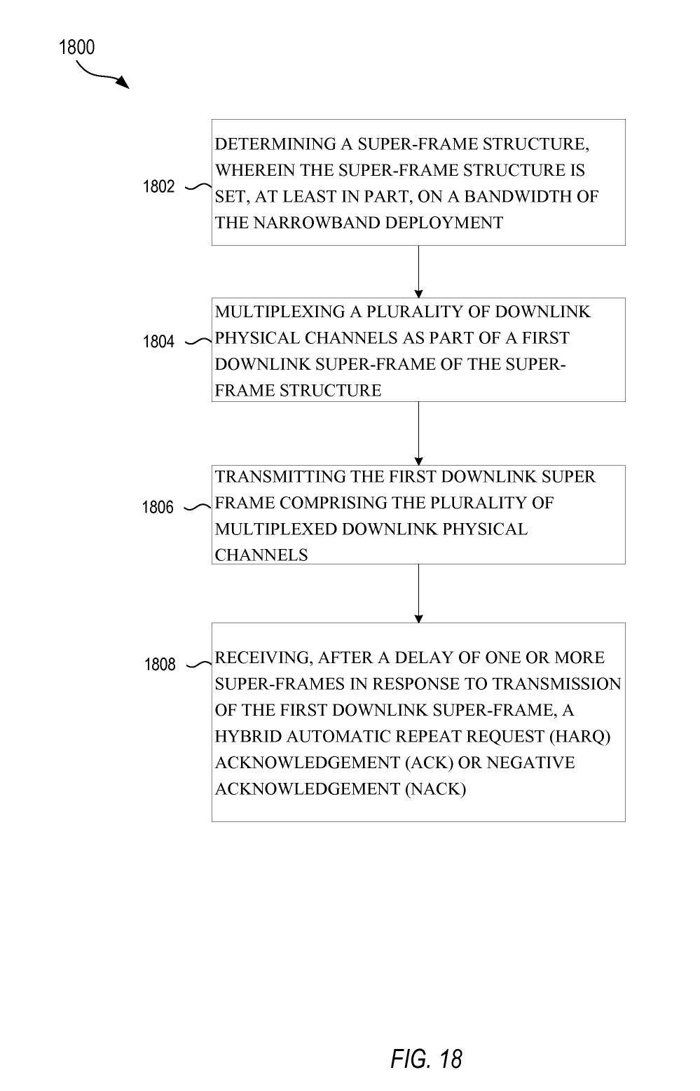

FIG. 18 then illustrates a method 1800 that may operate according to certain embodiments described herein. Operation 1802 involves determining a super-frame structure, where the super-frame structure is set, at least in part, on a bandwidth of the narrowband deployment. Operation 1804 then involves multiplexing a plurality of downlink physical channels as part of a first downlink super-frame of the super-frame structure. The first downlink super-frame is then transmitted with the plurality of multiplexed downlink physical channels in operation 1806, and in operation 1808, a HARQ ACK/NACK is received after a delay of one or more super-frames in response to transmission of the first downlink super-frame.

For any of the methods described above, various additional embodiments may operate with additional operations between the listed operations, and still further methods may operate with the operations described merged or arranged in different ways.

One example embodiment is an apparatus of an evolved nodeB (eNB) for machine-type communications (MTC) with narrowband deployment comprising control circuitry configured to determine a super-frame structure, wherein the super-frame structure is set, at least in part, on a bandwidth of the narrowband deployment; multiplex a plurality of downlink physical channels as part of a first downlink super-frame of the super-frame structure; along with communication circuitry configured to: transmit the first downlink super-frame comprising the plurality of multiplexed downlink physical channels; receive a plurality of uplink physical channels; and receive, in response to transmission of the first downlink super-frame, a hybrid automatic repeat request (HARQ) acknowledgement (ACK) or negative acknowledgement (NACK).

Additional such embodiments may operate where the plurality of downlink physical channels are multiplexed using frequency division multiplexing (FDM).

Additional such embodiments may operate where the plurality of downlink physical channels are multiplexed using time division multiplexing (TDM).

Additional such embodiments may operate where the plurality of downlink physical channels comprises an MTC Physical Broadcast Channel (M-PBCH).

Additional such embodiments may operate where the plurality of downlink physical channels further comprises MTC Synchronization Channel (M-SCH), MTC control channel, MTC Physical Downlink Shared Channel (M-PDSCH), MTC Physical Multicast Channel (M-PMCH).

Additional such embodiments may operate where the control circuitry is further configured to generate an MTC Master Information Block(M-MIB), wherein the M-PBCH is generated to carry the M-MIB.

Additional such embodiments may operate where the M-MIB comprises a plurality of transmitted parameters for initial access to the eNB.

Additional such embodiments may operate where the M-PBCH is transmitted in a single radio frame of the super-frame structure.

Additional such embodiments may operate where the super-frame structure including a starting subframe for the super-frame structure and a periodicity of the super-frame structure is set by a higher layer of the eNB.

Additional such embodiments may operate where the communication circuitry is further configured to receive an MTC physical uplink shared channel (M-PUSCH) and transmit a physical downlink control channel (M-PDCCH) wherein a delay between transmission of M-PUSCH and M-PDCCH transmission is one super-frame; and wherein the delay between the delay between the transmission of M-PDCCH and M-PUSCH retransmission is three super-frames or one super-frame.

Additional such embodiments may operate where a delay between transmission of the downlink super-frame and receipt of the HARQ ACK or NACK is two super-frames.

Additional such embodiments may operate where the communication circuitry is further configured to transmit an MTC physical downlink shared channel (M-PDSCH) and receive a physical uplink control channel (M-PUCCH); wherein a delay between transmission of M-PDSCH and M-PUCCH transmission is three super-frames or one super-frame; and wherein the delay between the delay between the transmission of M-PUCCH and M-PDSCH retransmission is one super-frame.

Additional such embodiments may operate where multiple HARQ processes are configured in the first downlink super-frame, wherein multiple MTC physical downlink control channels (M-PDCCHs) schedule multiple M-PDSCHs in one super-frame.

An additional embodiment is a method for machine-type communications (MTC) with narrowband deployment performed by an evolved node B (eNB) comprising: determining a super-frame structure, wherein the super-frame structure is set, at least in part, on a bandwidth of the narrowband deployment; multiplexing a plurality of downlink physical channels as part of a first downlink super-frame of the super-frame structure; and transmitting the first downlink super-frame comprising the plurality of multiplexed downlink physical channels; and receiving, in response to transmission of the first downlink super-frame, a hybrid automatic repeat request (HARQ) acknowledgement (ACK) or negative acknowledgement (NACK).

Additional such embodiments may operate where the control circuitry is further configured to generate an MTC Master Information Block(M-MIB), wherein the M-PBCH is generated to carry the M-MIB.

Additional such embodiments may operate where the M-PBCH is transmitted in a single radio frame of the super-frame structure; and

wherein the super-frame structure including a starting subframe for the super-frame structure and a periodicity of the super-frame structure is set by a higher layer of the eNB.

Additional such embodiments may operate in transmitting an MTC physical downlink shared channel (M-PDSCH) and receive a physical uplink control channel (M-PUCCH); wherein a delay between transmission of M-PDSCH and M-PUCCH transmission is three super-frames or one super-frame; and wherein the delay between the delay between the transmission of M-PUCCH and M-PDSCH retransmission is one super-frame.

An additional embodiment is a non-transitory computer readable medium comprising instructions that, when executed by one or more processors, cause an evolved node B to perform a set of operations comprising: determining a super-frame structure, wherein the super-frame structure is set, at least in part, on a bandwidth of the narrowband deployment; multiplexing a plurality of downlink physical channels as part of a first downlink super-frame of the super-frame structure; transmitting the first downlink super-frame comprising the plurality of multiplexed downlink physical channels; receiving, after a delay of one or more super-frames in response to transmission of the first downlink super-frame, a hybrid automatic repeat request (HARQ) acknowledgement (ACK) or negative acknowledgement (NACK).

Additional such embodiments may operate where the plurality of downlink physical channels comprises an MTC Physical Broadcast Channel (M-PBCH); and where the control circuitry is further configured to generate an MTC Master Information Block(M-MIB), wherein the M-PBCH is generated to carry the M-MIB.

Additional such embodiments may operate where the plurality of downlink physical channels further comprises MTC Synchronization Channel (M-SCH), MTC control channel comprising a physical uplink control channel (M-PUCCH), MTC Physical Downlink Shared Channel (M-PDSCH), MTC Physical Multicast Channel (M-PMCH); wherein a delay between transmission of M-PDSCH and M-PUCCH transmission is three super-frames or one super-frame; and wherein the delay between the delay between the transmission of M-PUCCH and M-PDSCH retransmission is one super-frame.

Another embodiment is an apparatus of a user equipment (UE) for machine-type communications (MTC) with narrowband deployment comprising control circuitry configured to: determine a super-frame structure, wherein the super-frame structure is set, at least in part, on a bandwidth of the narrowband deployment; multiplex a plurality of uplink physical channels as part of a first uplink super-frame of the super-frame structure; and transmit circuitry configured to transmit the first uplink super-frame comprising the plurality of multiplexed uplink physical channels; and receive circuitry configured to: receive a plurality of downlink physical channels; and receive, in response to transmission of the first uplink super-frame, a hybrid automatic repeat request (HARQ) acknowledgement (ACK) or negative acknowledgement (NACK).

Additional such embodiments may operate where the transmit circuitry is further configured to transmit an MTC physical downlink shared channel (M-PDSCH); wherein the receive circuitry is configured to receive a physical uplink control channel (M-PDCCH); wherein a delay between transmission of M-PUSCH and M-PDCCH transmission is one super-frame; and wherein the delay between the delay between the transmission of M-PDCCH and M-PUSCH retransmission is three super-frames or one super-frame.

Additional such embodiments may operate where the receive circuitry is further configured to receive an MTC physical broadcast channel (M-PBCH) transmission in a second super-frame.

Additional such embodiments may operate where the control circuitry is further configured to identify an MTC master information block (M-MIB) based on the M-PBCH.

A first set of additional examples of the presently described method, system, and device embodiments include the following, non-limiting configurations. Each of the following non-limiting examples can stand on its own, or can be combined in any permutation or combination with any one or more of the other examples provided below or throughout the present disclosure.

Example 1 may include an evolved node B (eNB)/User Equipment (UE) operable for machine type communication (MTC) within narrow system bandwidth, the eNB having computer circuitry comprising: a super-frame structure wherein downlink and uplink physical channels are multiplexed in a Time-division multiplexing (TDM) manner; a super-frame structure wherein downlink and uplink physical channels are multiplexed in a Frequency division multiplexing (FDM) manner; and a predefined Hybrid automatic repeat request (HARQ) procedure.

Example 2 may include the computer circuitry of example 1, wherein the eNB is configured to transmit at least one of the physical channels in the downlink: MTC Synchronization Channel (M-SCH), MTC Physical Broadcast Channel (M-PBCH), MTC control channel, MTC Physical Downlink Shared Channel (M-PDSCH), MTC Physical Multicast Channel (M-PMCH).

Wherein the eNB is configured to receive at least one of the physical channels in the uplink: MTC Physical Uplink Shared Channel (M-PUSCH), MTC Physical Random Access Channel (M-PRACH), MTC Physical Uplink Control Channel (M-PUCCH).

Example 3 may include the computer circuitry of example 1, wherein the super-frame configuration including the starting subframe and periodicity is predetermined, wherein the super-frame configuration including starting subframe and periodicity is configured by the higher layers.

Example 4 may include the computer circuitry of example 1, wherein the MTC control channel and M-PDSCH are transmitted in one downlink super-frame; wherein the M-SCH, M-PBCH, MTC control channel and M-PDSCH are transmitted in one downlink super-frame.

Example 5 may include the computer circuitry of example 4, wherein in the downlink super-frame, M-PBCH follows M-SCH transmission in time, wherein M-PDSCH follows MTC control channel transmission in time.

Example 6 may include the computer circuitry of example 4, wherein in the uplink super-frame, M-PUCCH and M-PUSCH are transmitted after M-PRACH.

Example 7 may include the computer circuitry of example 6, wherein M-PRACH and M-PUCCH transmission configuration is predefined or wherein M-PRACH and M-PUCCH transmission configuration is configured by the eNB.

Example 8 may include the computer circuitry of example 1, wherein MTC region is defined.

Example 9 may include the computer circuitry of example 8, wherein the starting OFDM symbols of MTC region in each subframe is predetermined or wherein the starting OFDM symbols of MTC region in each subframe is configured by the higher layers.

Example 10 may include the computer circuitry of example 1, wherein subframe offsets between downlink and uplink super-frame are configured.

Example 11 may include the computer circuitry of example 2, wherein M-PHICH is supported in the MTC control channel; or wherein M-PHICH is not supported in the MTC control channel.

Example 12 may include the computer circuitry of example 2, wherein M-PCFICH is supported in the MTC control channel, or wherein M-PCFICH is not supported in the MTC control channel.

Example 13 may include the computer circuitry of example 2, wherein M-PCFICH and M-PHICH are supported in the MTC control channel, wherein M-PCFICH is located in the first K₀ subframes of the control region while M-PHICH is allocated in the last K₁ subframes of the control region and wherein M-PDCCH is allocated in the resource elements which are not assigned for M-PCFICH and M-PHICH in the control region.

Example 14 may include the computer circuitry of example 2, wherein M-PCFICH and M-PHICH are supported in the MTC control channel, wherein M-PCFICH is located in the first M₀ subframes of the control region while M-PHICH is located in the M₁ subframes of the data region, wherein M-PDCCH and M-PDSCH are allocated in the resource elements which are not assigned for M-PCFICH in the control region and M-PHICH in the data region, respectively.

Example 15 may include the computer circuitry of example 1, wherein the delay between data transmission and ACK/NACK feedback is one super-frame; wherein the delay between ACK/NACK feedback and data retransmission is one super-frame.

Example 16 may include the computer circuitry of example 1, wherein the delay between data transmission and ACK/NACK feedback is two super-frames; wherein the delay between ACK/NACK feedback and data retransmission is two super-frames.

Example 17 may include the computer circuitry of example 1, wherein the delay between the transmission of M-PDSCH and M-PUCCH transmission is three super-frames or one super-frame; wherein the delay between the delay between the transmission of M-PUCCH and M-PDSCH retransmission is one super-frame.

Example 18 may include the computer circuitry of example 1, wherein the delay between the transmission of M-PUSCH and M-PHICH transmission is one super-frame; wherein the delay between the delay between the transmission of M-PHICH and M-PUSCH retransmission is three super-frames or one super-frame or one super-frame.

Example 19 may include the computer circuitry of example 1, wherein multiple HARQ processes are configured in one super-frame, wherein multiple M-PDCCHs schedule multiple M-PDSCHs and/or M-PUSCHs in one super-frame.

Example 20 may include an evolved Node B (“eNB”) adapted for machine-type communication (“MTC”) within narrow system bandwidth, the eNB comprising: control circuitry to multiplex a plurality of downlink physical channels for downlink transmission to a user equipment (“UE”) and to process a plurality of multiplexed uplink physical channels received from the UE; transmit circuitry, coupled with the control circuitry, to transmit a downlink super-frame to the UE that includes the multiplexed plurality of downlink physical channels, the downlink super-frame comprising a plurality of downlink subframes; and receive circuitry, coupled with the control circuitry, to receive an uplink super-frame that includes the plurality of multiplexed uplink physical channels from the UE, the uplink super-frame comprising a plurality of uplink subframes.

Example 21 may include the eNB of example 20, wherein the control circuitry is to multiplex the plurality of downlink physical channels according to time-division multiplexing (“TDM”) or frequency-division multiplexing (“FDM”).

Example 22 may include the eNB of example 20, wherein the receive circuitry is further to receive, in an uplink super-frame from the UE, a Hybrid Automatic Repeat Request (“HARQ”) Acknowledgement (“ACK”) or Non-Acknowledgement (“NACK”) message associated with the downlink super-frame, further wherein control circuitry is to cause the transmit circuitry is to re-transmit the multiplexed plurality of downlink physical channels in another downlink super-frame if the receive circuitry receives the HARQ NACK.

Example 23 may include the eNB of any of examples 20-22, wherein the respective starting subframes of the uplink and downlink super-frames are predetermined.

Example 24 may include the eNB of any of examples 20-22, wherein a first periodicity associated with downlink transmission of the plurality of multiplexed downlink physical channels and a second periodicity associated with uplink reception of the plurality of multiplexed uplink physical channels are predetermined.

Example 25 may include the eNB of any of examples 20-22, wherein the plurality of downlink physical channels includes at least one of an MTC Synchronization Channel (“M-SCH”), an MTC Physical Broadcast Channel (“M-PBCH”), an MTC control channel, an MTC Physical Downlink Shared Channel (“M-PDSCH”), or an MTC Physical Multicast Channel (“M-PMCH”) and the plurality of multiplexed uplink physical channels received from the UE includes at least one of an MTC Physical Uplink Shared Channel (“M-PUSCH”), an MTC Physical Random Access Channel (“M-PRACH”), or an MTC Physical Uplink Control Channel (“M-PUCCH”).

Example 26 may include the eNB of example 25, wherein the MTC control channel includes an MTC Physical Control Format Indicator Channel (“M-PCFICH”) and an MTC Physical Hybrid ARQ Indicator Channel (“M-PHICH”), and further wherein the control circuitry is to allocate at least one subframe of the downlink super-frame to the M-PCFICH and at least one other subframe of the downlink super-frame to the M-PHICH.

Example 27 may include the eNB of example 26, wherein the transmit circuitry is to transmit the at least one subframe allocated to the M-PCFICH and the at least one other subframe allocated to the M-PHICH in a control region of the downlink super-frame.

Example 28 may include the eNB of example 26, wherein the transmit circuitry is to transmit the at least one subframe allocated to the M-PCFICH in a control region of the downlink super-frame and the at least one other subframe allocated to the M-PHICH in a data region of the downlink super-frame.

Example 29 may include a method comprising: multiplexing, by an evolved Node B (“eNB”), a plurality of downlink physical channels for machine-type communication (“MTC”) within narrow system bandwidth; transmitting, to a user equipment (“UE”), a downlink super-frame that includes the multiplexed plurality of downlink physical channels, the downlink super-frame comprising a plurality of downlink subframes; and receiving, from the UE, at least one Hybrid Automatic Repeat Request (“HARQ”) Acknowledgement (“ACK”) message or at least one HARQ Non-Acknowledgement (“NACK”) message based on the transmitting of the downlink super-frame.

Example 30 may include the method of example 29, wherein the at least one HARQ ACK message or at least one HARQ NACK message is received in an uplink super-frame according to a predetermined schedule for HARQ message transmission, the uplink super-frame comprised of a plurality of uplink subframes.

Example 31 may include the method of example 29, further comprising: retransmitting, according to a predetermined schedule for retransmission, the multiplexed plurality of downlink physical channels in a downlink super-frame based on the receiving of the HARQ NACK message.

Example 32 may include the method of example 29, further comprising: transmitting, to the UE, a predetermined starting subframe and a predetermined number of subframes to be used by the UE for the uplink super-frame.

Example 33 may include the method of example 32, wherein the predetermined starting subframe and the predetermined number of subframes are transmitted to the UE in a Master Information Block (“MIB”) or a System Information Block (“SIB”).

Example 34 may include the method of any of examples 29-32, wherein the plurality of downlink physical channels includes at least one of an MTC Synchronization Channel (“M-SCH”), an MTC Physical Broadcast Channel (“M-PBCH”), an MTC control channel, an MTC Physical Downlink Shared Channel (“M-PDSCH”), or an MTC Physical Multicast Channel (“M-PMCH”).

Example 35 may include the method of example 34, wherein the MTC control channel includes an MTC Physical Control Format Indicator Channel (“M-PCFICH”) and an MTC Physical Hybrid ARQ Indicator Channel (“M-PHICH”), and method further comprising: allocating at least one subframe of the downlink super-frame to the M-PCFICH; and allocating at least one other subframe of the downlink super-frame to the M-PHICH.

Example 36 may include the method of example 35, wherein the at least one subframe allocated to the M-PCFICH and the at least one other subframe allocated to the M-PHICH are associated with a control region of the downlink super-frame.

Example 37 may include the method of example 35, wherein the at least one subframe allocated to the M-PCFICH is associated with a control region of the downlink super-frame and the at least one other subframe allocated to the M-PHICH is associated with a data region of the downlink super-frame.

Example 38 may include the method of any of examples 29-32, further comprising: receiving, from the UE, an uplink super-frame that includes the plurality of multiplexed uplink physical channels, the uplink super-frame comprising a plurality of uplink subframes and the plurality of multiplexed uplink physical channels including at least one of an MTC Physical Uplink Shared Channel (“M-PUSCH”), an MTC Physical Random Access Channel (“M-PRACH”), or an MTC Physical Uplink Control Channel (“M-PUCCH”); and transmitting, to the UE according to a predetermined schedule for HARQ message transmission, a downlink subframe that includes at least one HARQ ACK message or at least one HARQ NACK message based on the receiving of the uplink super-frame.

Example 39 may include a user equipment (“UE”) adapted for machine-type communication (“MTC”) within narrow system bandwidth, the UE comprising: control circuitry to multiplex a plurality of uplink physical channels for uplink transmission to an evolved Node B (“eNB”) and to process a plurality of multiplexed downlink physical channels received from the eNB; transmit circuitry, coupled with the control circuitry, to transmit an uplink super-frame to the eNB that includes the multiplexed plurality of uplink physical channels, the uplink super-frame comprising a plurality of uplink subframes; and receive circuitry, coupled with the control circuitry, to receive a downlink super-frame that includes the plurality of multiplexed downlink physical channels from the eNB, the downlink super-frame comprising a plurality of downlink subframes.

Example 40 may include the UE of example 39, wherein the control circuitry is to multiplex the plurality of downlink physical channels according to time-division multiplexing (“TDM”) or frequency-division multiplexing (“FDM”).

Example 41 may include the UE of example 39, wherein the transmit circuitry is further to transmit, in an uplink super-frame, a Hybrid Automatic Repeat Request (“HARQ”) Acknowledgement (“ACK”) or Non-Acknowledgement (“NACK”) message based on the reception of the downlink super-frame.

Example 42 may include the UE of any of examples 39-41, wherein a starting subframe and a periodicity associated with uplink transmission of the uplink super-frame are predetermined.

Example 43 may include the UE of any of examples 39-41, wherein the receive circuitry is further to receive, from the eNB, a starting subframe and a periodicity associated with uplink transmission of the uplink super-frame in a Master Information Block (“MIB”) or a System Information Block (“SIB”).

Example 44 may include the UE of any of examples 39-41, wherein the plurality of downlink physical channels includes at least one of an MTC Synchronization Channel (“M-SCH”), an MTC Physical Broadcast Channel (“M-PBCH”), an MTC control channel, an MTC Physical Downlink Shared Channel (“M-PDSCH”), or an MTC Physical Multicast Channel (“M-PMCH”) and the plurality of multiplexed uplink physical channels received from the UE includes at least one of an MTC Physical Uplink Shared Channel (“M-PUSCH”), an MTC Physical Random Access Channel (“M-PRACH”), or an MTC Physical Uplink Control Channel (“M-PUCCH”).

Example 45 may include the UE of example 44, wherein the MTC control channel includes an MTC Physical Control Format Indicator Channel (“M-PCFICH”) and an MTC Physical Hybrid ARQ Indicator Channel (“M-PHICH”).

Example 46 may include the UE of example 45, wherein the receive circuitry is to receive at least one subframe allocated to the M-PCFICH and at least one other subframe allocated to the M-PHICH in a control region of the downlink super-frame.

Example 47 may include the UE of example 45, wherein the receive circuitry is to receive at least one subframe allocated to the M-PCFICH in a control region of the downlink super-frame and at least one other subframe allocated to the M-PHICH in a data region of the downlink super-frame.

Example 48 may include a method comprising: multiplexing, by an a user equipment (“UE”), a plurality of uplink physical channels for machine-type communication (“MTC”) within narrow system bandwidth; transmitting, to an evolved Node B (“eNB”), an uplink super-frame that includes the multiplexed plurality of uplink physical channels, the uplink super-frame comprising a plurality of uplink subframes; and receiving, from the eNB, at least one Hybrid Automatic Repeat Request (“HARQ”) Acknowledgement (“ACK”) message or at least one HARQ Non-Acknowledgement (“NACK”) message based on the transmitting of the uplink super-frame.

Example 49 may include the method of example 48, wherein the at least one HARQ ACK message or the at least one HARQ NACK message is received in a downlink super-frame according to a predetermined schedule for HARQ message reception, the downlink super-frame comprised of a plurality of downlink subframes.

Example 50 may include the method of example 48, further comprising: retransmitting, based on a predetermined schedule for retransmission, the multiplexed plurality of uplink physical channels in an, uplink super-frame based on the receiving of the HARQ NACK message.

Example 51 may include the method of example 48, further comprising: receiving, from the eNB, a predetermined starting subframe and a predetermined number of subframes associated with the uplink super-frame.

Example 52 may include the method of example 51, wherein the predetermined starting subframe and the predetermined number of subframes are received in a Master Information Block (“MIB”) or a System Information Block (“SIB”).

Example 53 may include the method of any of examples 48-51, wherein the plurality of uplink physical channels includes at least one of an MTC Physical Uplink Shared Channel (“M-PUSCH”), an MTC Physical Random Access Channel (“M-PRACH”), or an MTC Physical Uplink Control Channel (“M-PUCCH”).

Example 54 may include the method of any of examples 48-51, further comprising: receiving, from the eNB, a downlink super-frame that includes the plurality of multiplexed downlink physical channels, the downlink super-frame comprising a plurality of downlink subframes and the plurality of multiplexed downlink physical channels including at least one of an MTC Synchronization Channel (“M-SCH”), an MTC Physical Broadcast Channel (“M-PBCH”), an MTC control channel, an MTC Physical Downlink Shared Channel (“M-PDSCH”), or an MTC Physical Multicast Channel (“M-PMCH”); and transmitting, to the eNB, an uplink subframe that includes at least one HARQ ACK message or at least one HARQ NACK message based on the receiving of the uplink super-frame based on a predetermined schedule for HARQ message transmission.

Example 55 may include the method of example 54, wherein the MTC control channel includes an MTC Physical Control Format Indicator Channel (“M-PCFICH”) and an MTC Physical Hybrid ARQ Indicator Channel (“M-PHICH”), and further wherein the M-PCFICH is received in control region of the downlink super-frame and the M-PHICH is received in the control region or the data region of the downlink super-frame.

Example 56 may include one or more non-transitory computer-readable media comprising instructions configured to cause a user equipment (“UE”), upon execution by one or more processors of the UE, to perform the method of any of examples 48-55.

Example 57 may include an apparatus comprising means to perform the method of any of examples 48-55.

Example 58 may include one or more non-transitory computer-readable media comprising instructions configured to cause an evolved Node B (“eNB”), upon execution by one or more processors of the eNB, to perform the method of any of examples 29-38.

Example 59 may include an apparatus comprising means to perform the method of any of examples 29-38.

The foregoing description of one or more implementations provides illustration and description, but is not intended to be exhaustive or to limit the scope of the embodiments to the precise form disclosed. Modifications and variations are possible in light of the above teachings or may be acquired from practice of various implementations of the embodiments.

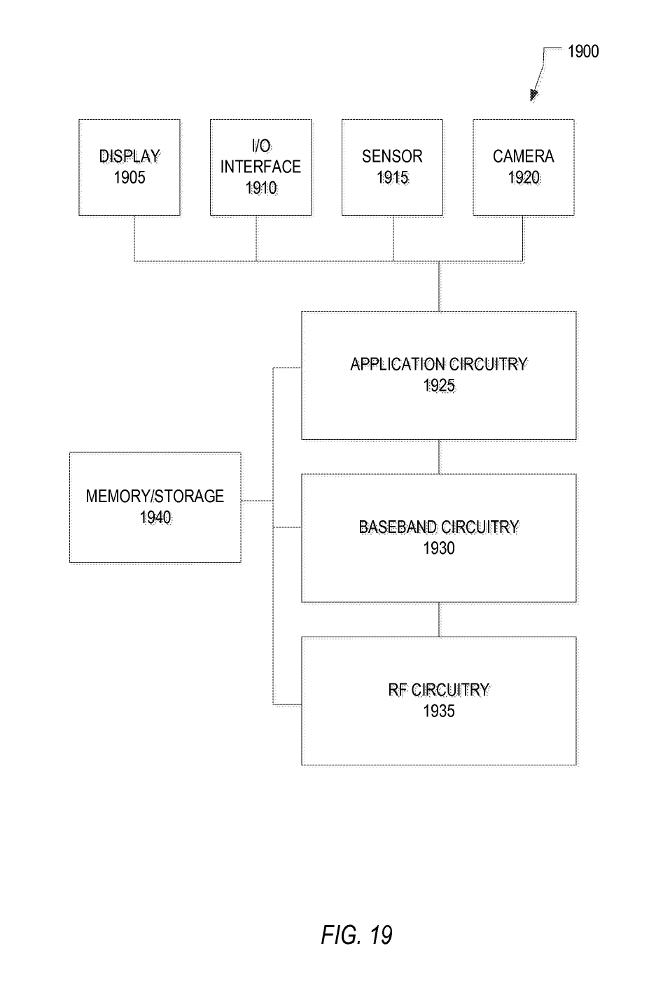

FIG. 19 then illustrates aspects of computing machine according to some example embodiments. Embodiments described herein may be implemented into a system 1900 using any suitably configured hardware and/or software. FIG. 19 illustrates, for some embodiments, an example system 1900 comprising radio frequency (RF) circuitry 1935, baseband circuitry 1930, application circuitry 1925, memory/storage 1940, display 1905, camera 1920, sensor 1915, and input/output (I/O) interface 1910, coupled with each other at least as shown.

The application circuitry 1925 may include circuitry such as, but not limited to, one or more single-core or multi-core processors. The processor(s) may include any combination of general-purpose processors and dedicated processors (e.g., graphics processors, application processors, etc.). The processors may be coupled with memory/storage 1940 and configured to execute instructions stored in the memory/storage 1940 to enable various applications and/or operating systems running on the system 1900.

The baseband circuitry 1930 may include circuitry such as, but not limited to, one or more single-core or multi-core processors. The processor(s) may include a baseband processor. The baseband circuitry 1930 may handle various radio control functions that enables communication with one or more radio networks via the RF circuitry 1935. The radio control functions may include, but are not limited to, signal modulation, encoding, decoding, radio frequency shifting, etc. In some embodiments, the baseband circuitry 1930 may provide for communication compatible with one or more radio technologies. For example, in some embodiments, the baseband circuitry 1930 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1930 is configured to support radio communications of more than one wireless protocol may be referred to as multi-mode baseband circuitry.

In various embodiments, baseband circuitry 1930 may include circuitry to operate with signals that are not strictly considered as being in a baseband frequency. For example, in some embodiments, baseband circuitry 1930 may include circuitry to operate with signals having an intermediate frequency, which is between a baseband frequency and a radio frequency.

RF circuitry 1935 may enable communication with wireless networks using modulated electromagnetic radiation through a non-solid medium. In various embodiments, the RF circuitry 1935 may include switches, filters, amplifiers, etc. to facilitate the communication with the wireless network.

In various embodiments, RF circuitry 1935 may include circuitry to operate with signals that are not strictly considered as being in a radio frequency. For example, in some embodiments, RF circuitry 1935 may include circuitry to operate with signals having an intermediate frequency, which is between a baseband frequency and a radio frequency.

In various embodiments, the transmitter circuitry or receiver circuitry discussed above with respect to the UE or eNB may be embodied in whole or in part in one or more of the RF circuitry 1935, the baseband circuitry 1930, and/or the application circuitry 1925.

In some embodiments, some or all of the constituent components of a baseband processor or as the baseband circuitry 1930, the application circuitry 1925, and/or the memory/storage 1940 may be implemented together on a system on a chip (SOC).

Memory/storage 1940 may be used to load and store data and/or instructions, for example, for system 1900. Memory/storage 1940 for one embodiment may include any combination of suitable volatile memory (e.g., dynamic random access memory (DRAM)) and/or non-volatile memory (e.g., Flash memory).

In various embodiments, the I/O interface 1910 may include one or more user interfaces designed to enable user interaction with the system and/or peripheral component interfaces designed to enable peripheral component interaction with the system 1900. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments sensor 1915 may include one or more sensing devices to determine environmental conditions and/or location information related to the system 1900. In some embodiments, the sensors 1915 may include, but are not limited to, a gyro sensor, an accelerometer, a proximity sensor, an ambient light sensor, and a positioning unit. The positioning unit may also be part of, or interact with, the baseband circuitry 1930 and/or RF circuitry 1935 to communicate with components of a positioning network, e.g., a global positioning system (GPS) satellite. In various embodiments, the display 1905 may include a display (e.g., a liquid crystal display, a touch screen display, etc.).

In various embodiments, the system 1900 may be a mobile computing device such as, but not limited to, a laptop computing device, a tablet computing device, a netbook, an ultrabook, a smartphone, etc. In various embodiments, system 1900 may have more or less components, and/or different architectures.

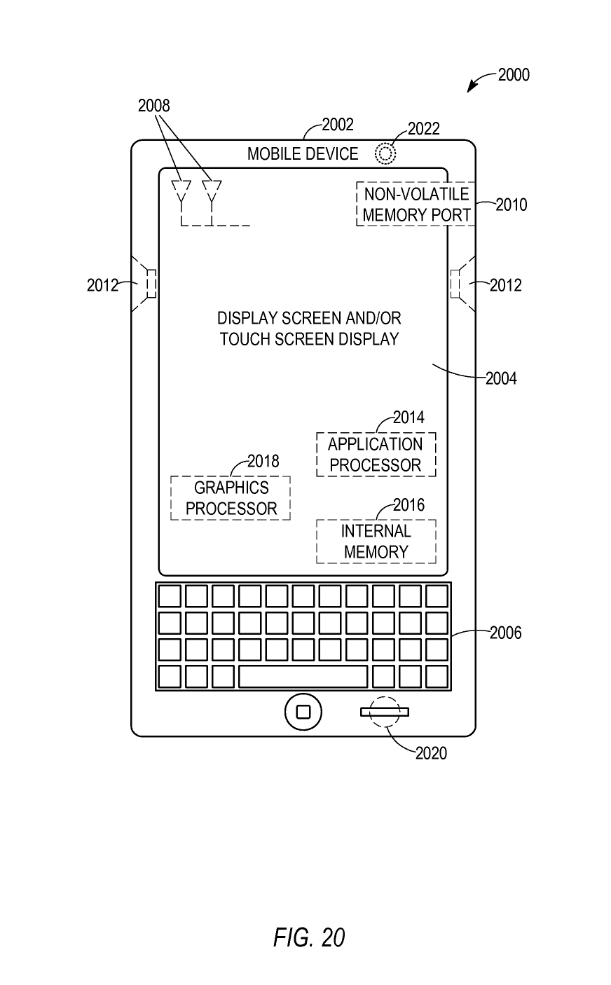

FIG. 20 shows an example UE, illustrated as UE 2000. UE 2000 may be an implementation of UE 110, UE 115, or any UE described herein. The UE 2000 can include one or more antennas configured to communicate with transmission station, such as a base station (BS), an evolved Node B (eNB), a RRU, or other type of wireless wide area network (WWAN) access point. The mobile device can be configured to communicate using at least one wireless communication standard including 3GPP LTE. WiMAX, High Speed Packet Access (HSPA), Bluetooth, and WiFi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 20 illustrates an example of a UE 2000. The UE 2000 can be any mobile device, a mobile station (MS), a mobile wireless device, a mobile communication device, a tablet, a handset, or other type of mobile wireless computing device. The UE 2000 can include one or more antennas 2008 within housing 2002 that are configured to communicate with a hotspot, base station (BS), an eNB, or other type of WLAN or WWAN access point. UE may thus communicate with a WAN such as the Internet via an eNB or base station transceiver implemented as part of an asymmetric RAN as detailed above. UE 2000 can be configured to communicate using multiple wireless communication standards, including standards selected from 3GPP LTE, WiMAX, High Speed Packet Access (HSPA), Bluetooth, and Wi-Fi standard definitions. The UE 2000 can communicate using separate antennas for each wireless communication standard or shared antennas for multiple wireless communication standards. The UE 2000 can communicate in a WLAN, a WPAN, and/or a WWAN.

FIG. 20 also shows a microphone 2020 and one or more speakers 2012 that can be used for audio input and output from the UE 2000. A display screen 2004 can be a liquid crystal display (LCD) screen, or other type of display screen such as an organic light emitting diode (OLED) display. The display screen 2004 can be configured as a touch screen. The touch screen can use capacitive, resistive, or another type of touch screen technology. An application processor 2014 and a graphics processor 2018 can be coupled to internal memory 2016 to provide processing and display capabilities. A non-volatile memory port 2010 can also be used to provide data input/output options to a user. The non-volatile memory port 2010 can also be used to expand the memory capabilities of the UE 2000. A keyboard 2006 can be integrated with the UE 2000 or wirelessly connected to the UE 2000 to provide additional user input. A virtual keyboard can also be provided using the touch screen. A camera 2022 located on the front (display screen) side or the rear side of the UE 2000 can also be integrated into the housing 2002 of the UE 2000. Any such elements may be used to generate information that may be communicated as uplink data via an asymmetric C-RAN and to receive information that may be communicated as downlink data via an asymmetric C-RAN as described herein.

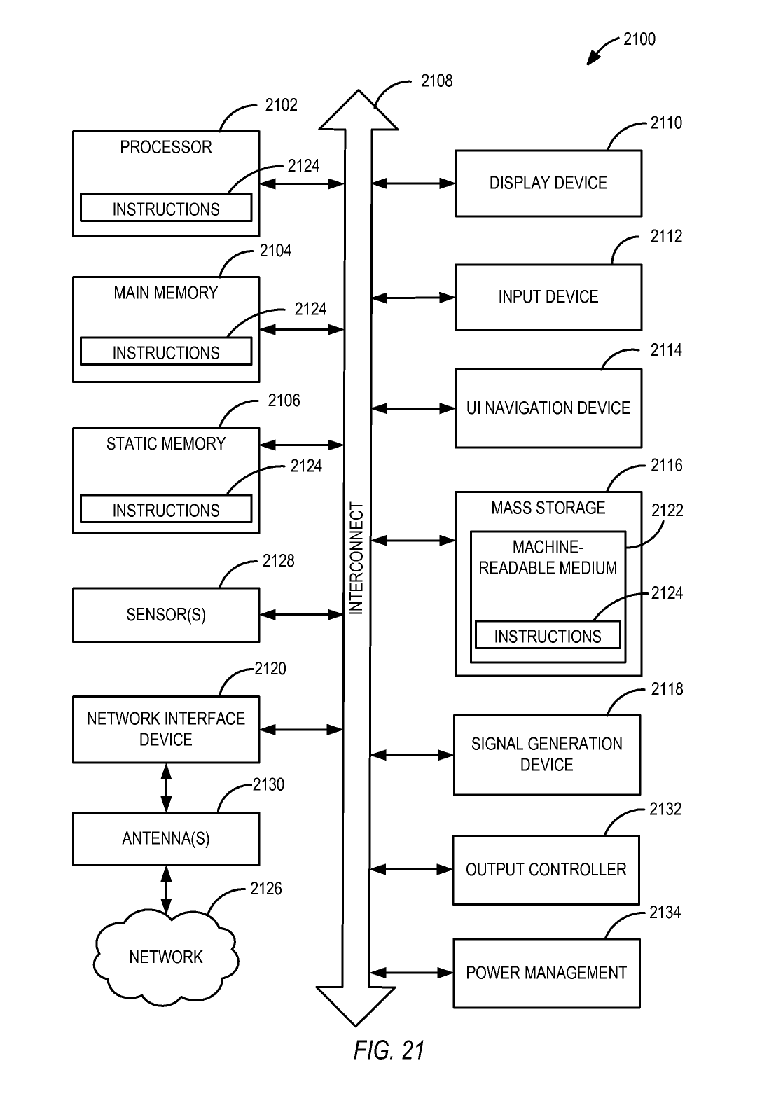

FIG. 21 is a block diagram illustrating an example computer system machine 2100 upon which any one or more of the methodologies herein discussed can be run, eNB 150 and UE 101. In various alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system machine 2100 includes a processor 2102 (e.g., a central processing unit (CPU), a graphics processing unit (GPU) or both), a main memory 2104 and a static memory 2106, which communicate with each other via an interconnect 2108 (e.g., a link, a bus, etc.). The computer system machine 2100 can further include a video display unit 2110, an alphanumeric input device 2112 (e.g., a keyboard), and a user interface (UI) navigation device 2114 (e.g., a mouse). In one embodiment, the video display unit 2110, input device 2112 and UI navigation device 2114 are a touch screen display. The computer system machine 2100 can additionally include a storage device 2116 (e.g., a drive unit), a signal generation device 2118 (e.g., a speaker), an output controller 2132, a power management controller 2134, and a network interface device 2120 (which can include or operably communicate with one or more antennas 2130, transceivers, or other wireless communications hardware), and one or more sensors 2128, such as a Global Positioning Sensor (GPS) sensor, compass, location sensor, accelerometer, or other sensor.

The storage device 2116 includes a machine-readable medium 2122 on which is stored one or more sets of data structures and instructions 2124 (e.g., software) embodying or utilized by any one or more of the methodologies or functions described herein. The instructions 2124 can also reside, completely or at least partially, within the main memory 2104, static memory 2106, and/or within the processor 2102 during execution thereof by the computer system machine 2100, with the main memory 2104, static memory 2106, and the processor 2102 also constituting machine-readable media.

While the machine-readable medium 2122 is illustrated in an example embodiment to be a single medium, the term “machine-readable medium” can include a single medium or multiple media (e.g., a centralized or distributed database, and/or associated caches and servers) that store the one or more instructions 2124. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The instructions 2124 can further be transmitted or received over a communications network 2126 using a transmission medium via the network interface device 2120 utilizing any one of a number of well-known transfer protocols (e.g., HTTP). The term “transmission medium” shall be taken to include any intangible medium that is capable of storing, encoding, or carrying instructions for execution by the machine, and includes digital or analog communications signals or other intangible medium to facilitate communication of such software.

Various techniques, or certain aspects or portions thereof may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The base station and mobile station may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Various embodiments may use 3GPP LTE/LTE-A, IEEE 2102.11, and Bluetooth communication standards. Various alternative embodiments may use a variety of other WWAN, WLAN, and WPAN protocols and standards can be used in connection with the techniques described herein. These standards include, but are not limited to, other standards from 3GPP (e.g., HSPA+, UMTS), IEEE 2102.16 (e.g., 2102.16p), or Bluetooth (e.g., Bluetooth 20.0, or like standards defined by the Bluetooth Special Interest Group) standards families. Other applicable network configurations can be included within the scope of the presently described communication networks. It will be understood that communications on such communication networks can be facilitated using any number of personal area networks, LANs, and WANs, using any combination of wired or wireless transmission mediums.

The embodiments described above can be implemented in one or a combination of hardware, firmware, and software. Various methods or techniques, or certain aspects or portions thereof, can take the form of program code (i.e., instructions) embodied in tangible media, such as flash memory, hard drives, portable storage devices, read-only memory (ROM), random-access memory (RAM), semiconductor memory devices (e.g., Electrically Programmable Read-Only Memory (EPROM), Electrically Erasable Programmable Read-Only Memory (EEPROM)), magnetic disk storage media, optical storage media, and any other machine-readable storage medium or storage device wherein, when the program code is loaded into and executed by a machine, such as a computer or networking device, the machine becomes an apparatus for practicing the various techniques.

A machine-readable storage medium or other storage device can include any non-transitory mechanism for storing information in a form readable by a machine (e.g., a computer). In the case of program code executing on programmable computers, the computing device can include a processor, a storage medium readable by the processor (including volatile and non-volatile memory and/or storage elements), at least one input device, and at least one output device. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

It should be understood that the functional units or capabilities described in this specification can have been referred to or labeled as components or modules, in order to more particularly emphasize their implementation independence. For example, a component or module can be implemented as a hardware circuit comprising custom very-large-scale integration (VLSI) circuits or gate arrays, off-the-shelf semiconductors such as logic chips, transistors, or other discrete components. A component or module can also be implemented in programmable hardware devices such as field programmable gate arrays, programmable array logic, programmable logic devices, or the like. Components or modules can also be implemented in software for execution by various types of processors. An identified component or module of executable code can, for instance, comprise one or more physical or logical blocks of computer instructions, which can, for instance, be organized as an object, procedure, or function. Nevertheless, the executables of an identified component or module need not be physically located together, but can comprise disparate instructions stored in different locations which, when joined logically together, comprise the component or module and achieve the stated purpose for the component or module.

Indeed, a component or module of executable code can be a single instruction, or many instructions, and can even be distributed over several different code segments, among different programs, and across several memory devices. Similarly, operational data can be identified and illustrated herein within components or modules, and can be embodied in any suitable form and organized within any suitable type of data structure. The operational data can be collected as a single data set, or can be distributed over different locations including over different storage devices, and can exist, at least partially, merely as electronic signals on a system or network. The components or modules can be passive or active, including agents operable to perform desired functions.

What is claimed is:

1. An apparatus of an evolved nodeB (eNB) for machine-type communications (MTC), the apparatus comprising:
control circuitry configured to:
determine a super-frame structure;
multiplex a plurality of downlink physical channels as part of a first downlink super-frame of the super-frame structure; and
communication circuitry configured to:
transmit the first downlink super-frame comprising the plurality of multiplexed downlink physical channels; and
receive, in response to transmission of the first downlink super-frame, a hybrid automatic repeat request (HARQ) acknowledgement (ACK) or negative acknowledgement (NACK).

2. The apparatus of claim 1 wherein the plurality of downlink physical channels are multiplexed using frequency division multiplexing (FDM).

3. The apparatus of claim 1 wherein the plurality of downlink physical channels are multiplexed using time division multiplexing (TDM).

4. The apparatus of claim 1 wherein the plurality of downlink physical channels comprises an MTC Physical Broadcast Channel (M-PBCH).

5. The apparatus of claim 4 wherein the plurality of downlink physical channels further comprises MTC Synchronization Channel (M-SCH), MTC control channel, MTC Physical Downlink Shared Channel (M-PDSCH), MTC Physical Multicast Channel (M-PMCH).

6. The apparatus of claim 4 wherein the control circuitry is further configured to generate an MTC Master Information Block(M-MIB), wherein the M-PBCH is generated to carry the M-MIB.

7. The apparatus of claim 6 wherein the M-MIB comprises a plurality of transmitted parameters for initial access to the eNB.

8. The apparatus of claim 7 wherein the M-PBCH is transmitted in a single radio frame of the super-frame structure.

9. The apparatus of claim 8 wherein the super-frame structure including a starting subframe for the super-frame structure and a periodicity of the super-frame structure is set by a higher layer of the eNB.

10. The apparatus of claim 1 wherein the communication circuitry is further configured to receive an MTC physical uplink shared channel (M-PUSCH) and transmit a physical downlink control channel (M-PDCCH);
wherein a delay between transmission of M-PUSCH and M-PDCCH transmission is one super-frame; and
wherein the delay between the delay between a transmission of M-PDCCH and M-PUSCH retransmission is one super-frame.

11. The apparatus of claim 1 wherein a delay between transmission of the first downlink super-frame and receipt of the HARQ ACK or NACK is two super-frames.

12. The apparatus of claim 1 wherein the communication circuitry is further configured to transmit an MTC physical downlink shared channel (M-PDSCH) and receive a physical uplink control channel (M-PUCCH);
wherein a delay between transmission of M-PDSCH and M-PUCCH transmission is one super-frame; and
wherein the delay between the delay between a transmission of M-PUCCH and M-PDSCH retransmission is one super-frame.

13. The apparatus of claim 12 wherein multiple HARQ processes are configured in the first downlink super-frame, wherein multiple MTC physical downlink control channels (M-PDCCHs) schedule multiple M-PDSCHs in one super-frame.

14. A non-transitory computer readable medium comprising instructions that, when executed by one or more processors, cause an evolved node B to:
determine a super-frame structure, wherein the super-frame structure is set, at least in part, on a bandwidth of the narrowband deployment;
multiplex a plurality of downlink physical channels as part of a first downlink super-frame of the super-frame structure; and
transmit the first downlink super-frame comprising the plurality of multiplexed downlink physical channels;
receive a plurality of uplink physical channels; and
receive, after a delay of one or more super-frames in response to transmission of the first downlink super-frame, a hybrid automatic repeat request (HARQ) acknowledgement (ACK) or negative acknowledgement (NACK).

15. The computer readable medium of claim 14 wherein the plurality of downlink physical channels comprises an MTC Physical Broadcast Channel (M-PBCH); and
wherein the M-PBCH is generated to carry an MTC Master Information Block (M-MIB).

16. The computer readable medium of claim 14 wherein the plurality of downlink physical channels further comprises MTC Synchronization Channel (M-SCH), MTC control channel comprising a physical uplink control channel (M-PUCCH), MTC Physical Downlink Shared Channel (M-PDSCH), MTC Physical Multicast Channel (M-PMCH);
wherein a delay between transmission of M-PDSCH and M-PUCCH transmission is one super-frame; and
wherein the delay between the delay between the transmission of M-PUCCH and M-PDSCH retransmission is one super-frame.

17. The computer readable medium of claim 14 wherein the plurality of downlink physical channels comprises an MTC Physical Broadcast Channel (M-PBCH); and
wherein the M-PBCH is generated to carry an MTC Master Information Block(M-MIB).

18. The computer readable medium of claim 17 wherein the M-MIB comprises a plurality of transmitted parameters for initial access to the eNB;
wherein the M-PBCH is transmitted in a single radio frame of the super-frame structure; and
wherein the super-frame structure including a starting subframe for the super-frame structure and a periodicity of the super-frame structure is set by a higher layer of the eNB.

19. The computer readable medium of claim 14 further comprising:
transmitting an MTC physical downlink shared channel (M-PDSCH) and receive a physical uplink control channel (M-PUCCH);
wherein a delay between transmission of M-PDSCH and M-PUCCH transmission is one super-frame; and
wherein the delay between the delay between transmission of M-PUCCH and M-PDSCH retransmission is one super-frame.

20. An apparatus of a user equipment (UE) for machine-type communications (MTC), the apparatus comprising:
control circuitry configured to:
determine a super-frame structure, wherein the super-frame structure is set, at least in part, on a coverage enhancement target of the narrowband deployment;
multiplex a plurality of uplink physical channels as part of a first uplink super-frame of the super-frame structure; and
transmit circuitry configured to transmit the first uplink super-frame comprising the plurality of multiplexed uplink physical channels; and
receive circuitry configured to:
receive a plurality of downlink physical channels; and
receive, in response to transmission of the first uplink super-frame, a hybrid automatic repeat request (HARQ) acknowledgement (ACK) or negative acknowledgement (NACK).

21. The apparatus of claim 20 wherein the transmit circuitry is further configured to transmit an MTC physical downlink shared channel (M-PDSCH);
wherein the receive circuitry is configured to receive a physical uplink control channel (M-PDCCH);
wherein a delay between transmission of M-PUSCH and M-PDCCH transmission is one super-frame; and
wherein the delay between the delay between transmission of M-PDCCH and M-PUSCH retransmission is one super-frame.

22. The apparatus of claim 21 wherein the receive circuitry is further configured to receive an MTC physical broadcast channel (M-PBCH) transmission in a second super-frame.

23. The apparatus of claim 22 wherein the control circuitry is further configured to identify an MTC master information block (M-MIB) based on the M-PBCH.
